(19) United States
(12) Patent Application Publication
(10) Pub. No.: US 2019/0170396 A1
(43) Pub. Date: Jun. 6, 2019

(54) SMART WATER HEATING SYSTEM AND METHODS USEFUL IN CONJUNCTION THEREWITH

(71) Applicant: SINDESY - IOT SOLUTIONS LTD., Beer Sheva (IL)

(72) Inventors: Yosef AZULAY, Herev Laet (IL); Zohar FRILING, Sede Warburg (IL); Yehuda LHIYANI, Beer Sheva (IL)

(73) Assignee: SINDESY - IOT SOLUTIONS LTD., Beer Sheva (IL)

(21) Appl. No.: 16/323,757

(22) PCT Filed: Jul. 19, 2017
(86) PCT No.: PCT/IL2017/050814

§ 371 Date: Feb. 6, 2019

Related U.S. Application Data
(60) Provisional application No. 62/372,011, filed on Aug. 8, 2016.

(51) Int. Cl. F24H 1/22; F24H 9/20; F24F 11/32; F24H 1/08; F24D 19/10

(52) U.S. Cl. CPC F24H 1/225; F24H 9/2007; H04W 4/80; F24H 1/08; F24D 19/1006; F24F 11/32

(57) ABSTRACT

A smart boiler system serving boilers each equipped with sensor/s monitoring an aspect of boiler water heating functionality and a local controller collecting sensor data and communicating data to remote server, the system comprising a central server in data communication with said data network and including a processor having operational mode/s including a maintenance-needs-detection operational mode operative to scan data stored in a boiler data repository, on occasion, and to rank boilers accordingly, in terms of predetermined criterion defining maintenance need/s, and provide “push” output/s indicating a subset of boilers currently ranking high in terms of predetermined criterion defining at least one maintenance need.

### REFERENCE TO CO-PENDING APPLICATIONS

None.

### FIELD OF THIS DISCLOSURE

The present invention relates generally to heating systems and more particularly to water heating systems.

### BACKGROUND FOR THIS DISCLOSURE

Conventional technology constituting background to certain embodiments of the present invention is described in the following publications inter alia:

Israel Patent No. 210075 describes a system for controlling temperature of water in a hot water installation.

Nest.com distributes thermostats for domestic hot water control.

Patent US2014316585 describes remote maintenance technology.

Patent US2014371925 describes a cloud connected intelligent heater/chiller system.

Patent US2016010878 describes machine learning based smart water heater controller using wireless sensor networks.

Patent WO2015121856 describes an interactive learning water heating scheduler.

The link http://tinyurl.com/hatwbh9 describes a network to link water heaters inter alia to the Internet.

Patent US2016047569 describes a user-friendly network connected learning thermostat and related systems and methods.

Patent US2015276265 describes an intelligent water heater controller.

Patent US2016010878 describes a machine learning based smart water heater controller using wireless sensor networks.

Patent US2015039552 describes a method and apparatus for optimizing profit in predictive systems.

Patent EP1715254 (al) describes a predictive heating control system based on a meteorological forecast-heating information system.

The following link: http://www.pocket-lint.com/news.124710-considering-smart-heating-here-are-your-current-options describes state of the art smart heating.

The disclosures of all publications and patent documents mentioned in the specification, and of the publications and patent documents cited therein directly or indirectly, are hereby incorporated by reference. Materiality of such publications and patent documents to patentability is not conceded.

### SUMMARY OF CERTAIN EMBODIMENTS

Certain embodiments seek to provide a system for controlling the temperature of water in a hot water installation that comprises an array of one or more temperature sensors, arranged to measure accurately the water temperature in a water tank; a user interface adapted to receive input from a user; a heating member for heating the water in the water tank and a control unit adapted to receive information from the sensors array and/or user interface. This unit controls the operation of the heating member. The system is retrofitted to most hot water installations, adapted to heat a precise amount of water according to the input requested by the user, the system further considers usage profile, for minimizing the heating time and power consumption.

Certain embodiments seek to provide a system to allow boiler manufacture/service providers or distributors to constantly monitor their installed products including a server, which, all year round and/or specifically in off-season times, scans a customer base to identify those with upcoming needs and provides proactive “push” output/notification to end users recommending that they service the boiler and/or replace the boiler, using a map indicating levels such as OK, poor functionality, or failure.

Certain embodiments seek to provide a solution that enables direct connection of the manufacturer to installed systems and consumers.

Certain embodiments of the present invention seek to provide at least one processor in communication with at least one memory, with instructions stored in such memory executed by the processor to provide functionalities which are described herein in detail.

Certain embodiments seek to provide a system to allow boiler distributors/manufacturers to monitor the products they have installed including a server, which, at all times or in off-season times, proactively scans a data repository to identify those consumer end users with upcoming needs and provides a proactive “push” output/notification recommending that customers service their boiler or buy a new boiler, and not wait until the boiler actually breaks down which often, inconveniently for all, occurs during the winter, which is peak season.

Certain embodiments seek to provide a smart boiler system which may according to certain embodiments include all of or any suitable subset of the following features:

1. Detect performance reduction using the data repository for comparing heating system performance for a consumer and between consumers, using any suitable performance parameter, such as, but not limited to, time required to heat a given volume of water from a given initial temperature to a given final temperature. Store each boiler's date of installation in the data repository and use new boilers as “ideally performing” benchmarks in each geographical region small enough to ensure uniform weather. Use a processor to translate into a maintenance need for at least one of shorter heating time, greater hot water availability, more effective electricity saving e.g. by comparing at least one of heating time, hot water availability, and electrical efficiency to a predetermined criterion.

2. Using the data repository to centrally detect failures and alert e.g. liquid leakage, poor functionality of heating factor, boiler explosion risk aka hyper pressure, failure of boiler's on-off switch, then reduce cost of failure by identifying maintenance need at times in which a maintenance work force for the boilers is not fully employed e.g. during summer which is off peak for this industry.

3. Using the data repository to support failure investigation from distance thereby to monitor at least one predefined maintenance need criterion: the agent may connect to a technician screen in (“view of”) the system and assess an individual boiler's maintenance need without actually coming to the boiler's premises e.g. an electricity problem, pipe related problem, boiler tank related problem, solar panels problem. If no problem is seen in the heating system, a visit cost may be saved and the customer can be directed from a distance to check other sources of the problem, such as investigating a consumer's home electricity circuit, and to take alternative action such as scheduling a service call by an electrician.

4. Using the data repository to leverage the user's collective power for better electricity rates. A group of consumers with similar hot water needs (e.g. heating time can be provided during the day) may be detected by the central server. If the server is able to identify user groups with common needs (e.g. shower within the 7 am-8 am time window, location), this may be communicated to a service provider due to its costing relevance and default boiler scheduling may then be controlled accordingly.

5. A cost-effective water heating solution by supporting electricity companies', manufactures', distributors' ability to offer controlled heating times stressing low cost power off-peak.

6. Using the data repository to centrally (or locally) detect leakage or partial to full blockage constituting a maintenance need by providing flow meters at all inlets & outlets and comparing simultaneous readings therefrom. In case of a blockage, the pipes' patency decreases and water flow is found to be slower. In case of a leakage the inlet flow meter readings show movement while the outlet flow meter readings are static hence show no movement indicating water escape not through the outlet, rather through a hole in pipes or tank. Forecasting expected maintenance may be conducted by constantly monitoring the boiler behavior on an ongoing basis and comparing the boiler's current behavior to a boiler's behavior e.g. the same boiler's behavior, one during its first day or month of operation which may be saved as an optimal baseline. The server may compare to another boiler of the same type and model, same year of manufacture, same geo-location, or may create baselines between different models or manufacturers. For example, by monitoring water flow it may be possible to detect decreased water flow over time due to calcification, and to predict that a full blockage will be due in few days/month. This enables the consumer or manufacturer to address the issue beforehand and schedule a routine service call, thereby to reduce the probability of emergency calls. This in turn enables the manufacturer to make sure customers are ready for the peak season of boiler usage, which is during the winter. And/or, for example, measuring boiler heating efficiency over time and comparing current efficiency to heat X amount of water within Y amount of time internally and understanding its degraded capability due to calcium and forecast may be used to determine economically when and whether to order preventative maintenance. Another example relevant to boilers with solar panels which, during the summer do not use electricity for heating water, is that such boilers' summer operation tends to obscure the fact that the electric heating system is not functional, or is only partially functional, as described below.

Alternatively or in addition, if water flow into and out of the boiler is measured e.g. as described herein, the server may detect leakage from the boiler itself. In most cases leakages start to occur gradually. However, initial minor leakage creates corrosion that in turn contributes to leakage deterioration and can cause damage to the boiler itself and/or to the surroundings. By detecting the leakage early, the server may proactively engage a few weeks/months prior to needed emergency maintenance or severe leakage when not at home, and prevent severe corrosion to the boiler itself.

Comparisons may be conducted by the central server, e.g. in terms of percentage of water loss, between day 1 of usage and the current time or between the current time of a given boiler and the current time % water loss of other boiler systems. Based on an individual boiler's history maintained in the data repository, the server may learn the deterioration sensed by various sensors until the point of total failure, and may then predict expected total failure e.g. total failure due to leakage at specific physical points in the boiler. A maintenance need criterion may then be determined by suitable analysis of the deterioration to select a criterion (point along the deterioration graph) which is timely enough to provide maintenance prior to failure.

Generally, individual boilers' sensor histories maintained in the data repository may be used to derive deterioration graphs culminating in eventual failure of the boiler. According to certain embodiments, technicians log in each boiler's failure (e.g. total failure which warrants boiler replacement), time-stamped, and indicate a reason therefor typically from among a predetermined set of possible reasons each of which is typically associated with a specific set of sensor/s. For example, “total failure due to leakage at point x in the boiler” may be associated with water meters just upstream of and just downstream of point x. The server may, for several boilers which experienced total failure, graph the difference between the two water meters over time, and combine the resulting graphs to yield a generic graph useful in predicting “total failure due to leakage at point x in the boiler”. A suitable criterion for the maintenance need of repairing point x in the boiler, may be derived from this graph by selecting a point P on the graph which is suitably temporally distant from failure (e.g. 2 weeks before expected failure) and determining the difference between upstream and downstream water meters (relative to point x) which corresponds to that point (e.g. the average difference between the 2 water meters 2 weeks before failure is typically y, hence y is the criterion for the maintenance need of repairing point x in the boiler).

6. The system can learn from a personal calendar whether the consumer is so distant from home (e.g. more than an hour from home) as to obviate hot water at that time. In this case the central server may command the local controller to cancel the un-necessary default heating schedule and so save electricity and money. This feature may be operative in conjunction with a mobile application residing on a mobile device carried by boiler end users, which has a calendar that provides access to the mobile application. The application may for example detect predefined words that imply the boiler end user is away from home, such as: vacation, flight, or visit, and accordingly the server may adjust that end user's boiler programming.

7. Allow multiple level temperature tracking by providing, for at least some boilers, sensors inside tank including several temperature sensors at different heights adjusted both for vertical & horizontal tank positions, and computing at least one maintenance need accordingly. For example, as described below, if a horizontally lower sensor yields a temperature reading higher than the thermostat configuration—that thermostat is malfunctioning since heat rises. In this case the controller may be programmed to send a relatively non-urgent alert to the server, and the server sends an alert to the consumer/manufacturer. If the temperature is still rising and reaches a predetermined upper set limit, the controller can shut down the heating system and send a notification to the server that will be forwarded to the consumer/manufacturer.

8. Detect thermostat failure—the central server typically initiates action once the temperature inside the boiler's tank is above the temperature limit defined to the thermostat. If the thermostat does not stop the heating action it may be assumed to be broken which is a suitable criterion for a “replace thermostat” maintenance need. Typically, whenever the temperature sensed by the temperature sensor with the lowest reading (e.g. the sensor out of, say, 5 total provided that is located closest to the thermostat) exceeds a threshold temperature e.g. 70 degrees C., an alert is generated, e.g. through a mobile app communicating with the central server, to warn the consumer (aka boiler end user) and/or a maintenance need may be registered at the central server. Above 80 degrees C. (say), the central server may additionally command the local controller to shut the heater down.

9. Explosion prevention: adding a pressure sensor (e.g. as shown at reference numeral 30 in FIG. 1) to provide this feedback to the local controller directly and typically via the local controller also to the central server, thereby to achieve shutdown of the heating system by the local controller in the event that pressure inside the tank is above normal and/or generate an urgent “danger: boiler explosion risk” maintenance need at the central server. Alternatively or in addition, if dynamic readings are coming in from an entry flow meter but static readings indicating no movement are coming in (to the local controller) from an exit flow meter, leakage is possible. However if the temperature is above the thermostat limit (say 60-70 degrees C.) and no leakage has been discerned, then an urgent (possible explosion risk-switch pressure regulator or thermostat” maintenance need) criterion may be defined since it is assumed that either the thermostat is not working, or the pressure regulator is not working. If temperature inside the tank rises, the pressure rises as well, and a properly functioning pressure regulator would then respond by releasing water outside the boiler tank to reduce pressure, causing the controller/central server to detect “leakage”. If, at this specific point in time, no “leakage” is detected, then the pressure regulator is not working, placing the tank at risk of exploding in case of overheating, since the temperature may keep rising, as well as the pressure inside the tank, absent proper operation of the defective pressure regulator.

10. Reduce the end user's need to initiate cumbersome programming through use of multiple user profiles—the system may be adaptive and may learn individual end user's habits of water use based on conventional logic. Alternatively, or in addition, the system may create multiple profiles for each customer corresponding to typical multiple routines such as but not limited to any or all of: (I am alone, I have visitors, I am abroad). Responsively, the central server may choose the right profile and adjust commands to the local controller, accordingly.

11. An electronic sticker for identification purposes may be provided on the tank. In many cases confusion results when several tanks are deployed within a location co-owned by several end-users, such as the roof of an apartment building, and it is difficult to match each user and her or his tank when a maintenance professional (aka maintenance work force member or maintenance agent) arrives for a service visit. This may lead to the maintenance worker devoting her or his efforts to the wrong tank. An electronic sticker e.g. with a unique optical code associated in the data repository serving the central server, with the end user who owns the tank, may be scanned by the maintenance agent e.g. through a maintenance agent's smartphone application and the optical code may be sent to the central server which responsively may inform the technician that a specific tank does or does not belong to the boiler end user for whom the service call is being conducted.

For a building with a central system serving several apartments, this sticker may be placed on the relevant outlet. The flow meter in that case may serve as an indication as to the hot water usage of that apartment.

12. A flow meter in the outlet of the boiler may send hot water usage for purpose of consumer tracking usage and/or hot water service provider records.

According to certain embodiments, the service provider may receive this data or any other suitable predetermined type of data, to his admin page and/or CRM.

It is appreciated that the applicability of the embodiments shown and described herein is not limited to any particular hot water costing model and instead may be operative in conjunction with any suitable hot water costing model. For example, if desired, consumers may not purchase their own boiler and may instead receive hot water as a service e.g. they may pay per usage.

There is thus provided, in accordance with at least one embodiment of the present invention, The present invention typically includes at least the following embodiments:

### Embodiment 1

A smart boiler system operative in conjunction with a plurality of boilers wherein each individual boiler in the plurality is equipped with at least one sensor monitoring an aspect of the individual boiler's water heating functionality and a local controller collecting data from the sensor and communicating at least some of the data via a data network to a remote server, the system comprising:

a boiler data repository comprising computer storage operative to maintain at least some of the data; and

a central server in data communication with the data network and including a processor having at least one operational mode including a maintenance-needs-detection operational mode which is operative to scan data stored in the repository, on occasion, and to rank, accordingly, the plurality of boilers in terms of at least one predetermined criterion defining at least one maintenance need, and to provide at least one “push” output indicating a subset of the plurality of boilers currently ranking high in terms of the at least one predetermined criterion defining at least one maintenance need.

The term “local” refers to a controller installed in the same building as a boiler and/or in wired data communication with sensors in the boiler and/or in short-range radio communication with sensors in the boiler e.g. via WiFi, Bluetooth or Zigbee.

### Embodiment 2

A system according to any of the preceding embodiments wherein the central server has plural operational modes and wherein the maintenance-needs-detection operational mode is activated when a boiler maintenance workforce tends to be underemployed and is disabled when a boiler maintenance workforce tends to be fully employed, thereby to provide differential operation on-season and off-season.

### Embodiment 3

A system according to any of the preceding embodiments wherein the push output comprises, for at least some boilers in the subset, a replace/service indication of whether the boiler should be serviced or replaced, based on predefined logic defining whether a boiler should be serviced or should be replaced by combining the data.

### Embodiment 4

A system according to any of the preceding embodiments wherein the sensor comprises plural temperature sensors distributed at respective plural temperature sensor locations throughout the boiler, wherein the data includes water temperature readings collected by the controller from the plural temperature sensors and stamped to indicate which of the plural temperature sensors provided each reading and wherein computing the criterion defining at least one maintenance need includes comparing at least some of the water temperature readings to identify impaired functioning of at least one of a boiler's heating elements and, all other things being equal, to rank boilers suffering from impaired functioning of at least one heating element higher than boilers not suffering from impaired functioning of at least one heating element.

### Embodiment 5

A system according to any of the preceding embodiments wherein the boiler has plural water flow points each including a water inlet or a water outlet and the sensor comprises plural flow meters monitoring the plural water flow points and wherein the data includes water flow readings collected by the controller from the plural flow meters and stamped to indicate which of the plural flow meters provided each reading and wherein computing the criterion defining at least one maintenance need includes comparing at least some of the water flow readings to identify at least one water leakage malfunction and, all other things being equal, to rank boilers having at least one water leakage malfunction higher than boilers not having at least one water leakage malfunction.

### Embodiment 6

A system according to any of the preceding embodiments wherein the sensor comprises at least one pressure sensor interior of the boiler and wherein the remote server is operative to provide a high pressure emergency alert by applying predetermined boiler explosion prediction logic to the pressure sensor, even if the remote server is not in the maintenance-needs-detection operational mode.

### Embodiment 7

A system according to any of the preceding embodiments wherein the controller is also operative to control at least one aspect of operation of the boiler.

### Embodiment 8

A system according to any of the preceding embodiments and wherein the remote server, when in the maintenance-needs-detection operational mode, is operative to command at least one individual controller, which is local with respect to at least one individual boiler, to generate at least one predetermined testing state by controlling at least one aspect of operation of the boiler thereby to convert the boiler's current state to the testing state.

### Embodiment 9

A system according to any of the preceding embodiments and wherein the testing state comprises a specific interior temperature of water inside the boiler.

### Embodiment 10

A system according to any of the preceding embodiments wherein the remote server is operative, at least once, to compare data stored in the repository pertaining to an individual boiler to data stored in the repository pertaining to at least one boiler other than the individual boiler, thereby to identify at least one deviation of the individual boiler from at least one norm and wherein the criterion defining at least one maintenance need is computed as a function of at least the deviation from the norm.

### Embodiment 11

A system according to any of the preceding embodiments wherein the repository stores, for each specific boiler, that specific boiler's date of installation and wherein the data stored in the repository pertaining to at least one boiler other than the individual boiler comprises data pertaining only to a set of boilers whose date of installation is newer than a predetermined threshold data such that the norm comprises a benchmark of ideal performance.

### Embodiment 12

A system according to any of the preceding embodiments wherein the repository stores, for each specific boiler, that specific boiler's geographical location and wherein the set of boilers to which the individual boiler is compared includes only boilers whose geographical location shares weather conditions with the individual location as determined by a predetermined rule applied to boiler geographical locations thereby to identify geographical regions in which weather conditions are assumed to be uniform.

### Embodiment 13

A system according to any of the preceding embodiments wherein the “push” output comprises a diagnosis of the water leakage malfunction's location based on known locations of the plural flow meters and on the water flow readings stamped to indicate which of the plural flow meters provided each reading.

### Embodiment 14

A system according to any of the preceding embodiments wherein the maintenance-needs-detection operational mode is activated responsive to an input indication determined by processing at least one output from a boiler maintenance work force scheduler indicating that a boiler maintenance work force managed by the scheduler is underemployed and is disabled responsive to an input indication determined by processing at least one output from the boiler maintenance work force scheduler indicating that the boiler maintenance work force managed by the scheduler is fully employed.

For example, a work force scheduler may comprise any suitable software for maintaining the schedule of a boiler maintenance work force such as but not limited to Humanity, WebSchedule by Repilcon, GSM Tasks, HotSchedules. An indication may be derived therefrom, computationally by a processor or by manual inspection, of whether the boiler maintenance work force managed by the scheduler is or is about to be, in an upcoming time-window, underemployed or fully employed, using any suitable cut-off criterion or criteria to determine plural levels of utilization of the boiler maintenance work force managed by the scheduler e.g. drastically underemployed, moderately underemployed, and fully employed. The maintenance-needs-detection operational mode may be activated in the event that the work force is drastically underemployed, may or may not be activated in the event that the work force is moderately underemployed, and is typically not be activated in the event that the work force is fully employed Alternatively or in addition, a seasonal or weather-forecast based criterion may be used to determine, manually or by automatic programming, whether the maintenance-needs-detection operational mode should be activated. For example, the maintenance-needs-detection operational mode may be activated by default or manually, during a preprogrammed winter period and deactivated during a preprogrammed summer period. Or, the maintenance-needs-detection operational mode may be activated by default or manually, based on a weather forecast-based criterion such as at least n days with a daily forecast temperature below T and deactivated based on a weather forecast-based criterion such as at least n days with a daily forecast temperature above T.

### Embodiment 15

A computer program product, comprising a non-transitory tangible computer readable medium having computer readable program code embodied therein, said computer readable program code adapted to be executed to implement a method for providing smart boiler system operative in conjunction with a plurality of boilers wherein each individual boiler in said plurality is equipped with at least one sensor monitoring an aspect of the individual boiler's water heating functionality and a local controller collecting data from said sensor and communicating at least some of said data via a data network to a remote server, the method comprising:

Providing a boiler data repository comprising computer storage operative to maintain at least some of said data; and

Providing a central server in data communication with said data network and including a processor having at least one operational mode including a maintenance-needs-detection operational mode which is operative to scan data stored in said repository, on occasion, and to rank, accordingly, said plurality of boilers in terms of at least one predetermined criterion defining at least one maintenance need, and to provide at least one “push” output indicating a subset of said plurality of boilers currently ranking high in terms of said at least one predetermined criterion defining at least one maintenance need.

### Embodiment 16

A system according to any of the preceding embodiments wherein said ranking is determined at least partly by identifying at least one flow circle, monitored by plural flow sensors, which is leaking, by comparing plural readings obtained at corresponding times from said plural sensors.

### Embodiment 17

A method for providing smart boiler system operative in conjunction with a plurality of boilers wherein each individual boiler in said plurality is equipped with at least one sensor monitoring an aspect of the individual boiler's water heating functionality and a local controller collecting data from said sensor and communicating at least some of said data via a data network to a remote server, the method comprising:

Providing a boiler data repository comprising computer storage operative to maintain at least some of said data; and

Providing a central server in data communication with said data network and including a processor having at least one operational mode including a maintenance-needs-detection operational mode which is operative to scan data stored in said repository, on occasion, and to rank, accordingly, said plurality of boilers in terms of at least one predetermined criterion defining at least one maintenance need, and to provide at least one “push” output indicating a subset of said plurality of boilers currently ranking high in terms of said at least one predetermined criterion defining at least one maintenance need.

### Embodiment 18

The method of any of the preceding embodiments and also comprising providing a heat regulation malfunction alert indicating at least one of a heating element and a thermostat is faulty, if said flow circle is deemed to be leaking due to operation of a pressure regulator, and providing a leakage alert, otherwise.

### Embodiment 19

The method of any of the preceding embodiments and also comprising providing a pressure regulation malfunction alert if pressure is sensed and found to exceed a high-pressure threshold, and no leakage is identified.

Also provided, excluding signals, is a computer program comprising computer program code means for performing any of the methods shown and described herein when said program is run on at least one computer; and a computer program product, comprising a typically non-transitory computer-usable or -readable medium e.g. non-transitory computer-usable or -readable storage medium, typically tangible, having a computer readable program code embodied therein, said computer readable program code adapted to be executed to implement any or all of the methods shown and described herein. The operations in accordance with the teachings herein may be performed by at least one computer specially constructed for the desired purposes or general purpose computer specially configured for the desired purpose by at least one computer program stored in a typically non-transitory computer readable storage medium. The term “non-transitory” is used herein to exclude transitory, propagating signals or waves, but to otherwise include any volatile or non-volatile computer memory technology suitable to the application.

Any suitable processor/s, display and input means may be used to process, display e.g. on a computer screen or other computer output device, store, and accept information such as information used by or generated by any of the methods and apparatus shown and described herein; the above processor/s, display and input means including computer programs, in accordance with some or all of the embodiments of the present invention. Any or all functionalities of the invention shown and described herein, such as but not limited to operations within flowcharts, may be performed by any one or more of: at least one conventional personal computer processor, workstation or other programmable device or computer or electronic computing device or processor, either general-purpose or specifically constructed, used for processing; a computer display screen and/or printer and/or speaker for displaying; machine-readable memory such as optical disks, CDROMs, DVDs, BluRays, magnetic-optical discs or other discs; RAMs, ROMs, EPROMs, EEPROMs, magnetic or optical or other cards, for storing, and keyboard or mouse for accepting. Modules shown and described herein may include any one or combination or plurality of: a server, a data processor, a memory/computer storage, a communication interface, a computer program stored in memory/computer storage.

The term “process” as used above is intended to include any type of computation or manipulation or transformation of data represented as physical, e.g. electronic, phenomena which may occur or reside e.g. within registers and/or memories of at least one computer or processor. The term processor includes a single processing unit or a plurality of distributed or remote such units.

The above devices may communicate via any conventional wired or wireless digital communication means, e.g. via a wired or cellular telephone network or a computer network such as the Internet.

The apparatus of the present invention may include, according to certain embodiments of the invention, machine readable memory containing or otherwise storing a program of instructions which, when executed by the machine, implements some or all of the apparatus, methods, features and functionalities of the invention shown and described herein. Alternatively or in addition, the apparatus of the present invention may include, according to certain embodiments of the invention, a program as above which may be written in any conventional programming language, and optionally a machine for executing the program such as but not limited to a general purpose computer which may optionally be configured or activated in accordance with the teachings of the present invention. Any of the teachings incorporated herein may, wherever suitable, operate on signals representative of physical objects or substances.

The embodiments referred to above, and other embodiments, are described in detail in the next section.

Any trademark occurring in the text or drawings is the property of its owner and occurs herein merely to explain or illustrate one example of how an embodiment of the invention may be implemented.

Unless specifically stated otherwise, as apparent from the following discussions, it is appreciated that throughout the specification discussions, utilizing terms such as, “processing”, “computing”, “estimating”, “selecting”, “ranking”, “grading”, “calculating”, “determining”, “generating”, “reassessing”, “classifying”, “generating”, “producing”, “stereo-matching”, “registering”, “detecting”, “associating”, “superimposing”, “obtaining” or the like, refer to the action and/or processes of at least one computer/s or computing system/s, or processor/s or similar electronic computing device/s, that manipulate and/or transform data represented as physical, such as electronic, quantities within the computing system's registers and/or memories, into other data similarly represented as physical quantities within the computing system's memories, registers or other such information storage, transmission or display devices. The term “computer” should be broadly construed to cover any kind of electronic device with data processing capabilities, including, by way of non-limiting example, personal computers, servers, embedded cores, computing system, communication devices, processors (e.g. digital signal processor (DSP), microcontrollers, field programmable gate array (FPGA), application specific integrated circuit (ASIC), etc.) and other electronic computing devices.

The present invention may be described, merely for clarity, in terms of terminology specific to particular programming languages, operating systems, browsers, system versions, individual products, and the like. It will be appreciated that this terminology is intended to convey general principles of operation clearly and briefly, by way of example, and is not intended to limit the scope of the invention to any particular programming language, operating system, browser, system version, or individual product.

Elements separately listed herein need not be distinct components and alternatively may be the same structure. A statement that an element or feature may exist is intended to include (a) embodiments in which the element or feature exists; (b) embodiments in which the element or feature does not exist; and (c) embodiments in which the element or feature exist selectably e.g. a user may configure or select whether the element or feature does or does not exist.

Any suitable input device, such as but not limited to a sensor, may be used to generate or otherwise provide information received by the apparatus and methods shown and described herein. Any suitable output device or display may be used to display or output information generated by the apparatus and methods shown and described herein. Any suitable processor/s may be employed to compute or generate information as described herein and/or to perform functionalities described herein and/or to implement any engine, interface or other system described herein. Any suitable computerized data storage e.g. computer memory may be used to store information received by or generated by the systems shown and described herein. Functionalities shown and described herein may be divided between a server computer and a plurality of client computers. These or any other computerized components shown and described herein may communicate between themselves via a suitable computer network.

### BRIEF DESCRIPTION OF THE DRAWINGS

Certain embodiments of the present invention are illustrated in the following drawings:

FIG. 1 is a simplified pictorial diagram of one of a plurality of boilers wherein each individual boiler may communicate via a data network e.g. Internet with a central processor (not shown) thereby to provide a smart boiler system in accordance with certain embodiments.

FIGS. 2-5 are simplified flows of processes provided in accordance with certain embodiments which may for example be performed by the system of FIG. 1 e.g. in conjunction with the central processor.

FIGS. 6a-6e are tables presenting sensor values, actions and policies, some or all of which may be provided in accordance with certain embodiments, either stand-alone or in conjunction with the system of FIG. 1 and/or with any of the processes of FIGS. 2-5, 8a-8b, or all of them. The table may include some or any suitable subset of the rows and columns illustrated by way of example.

FIG. 7 is a simplified functional block diagram of a central processor or server which may be provided in accordance with certain embodiments, e.g. in data communication with the system of FIG. 1, e.g. to facilitate performance of any or all of the processes of FIGS. 2-5, e.g. to process any of the sensor values, perform any of the actions, and enforce any of the policies of FIGS. 6a-6e.

FIGS. 8a, 8b are simplified diagrams of boiler maintenance/replacement need prediction flow, which may be based on a remote pressure test and which are provided in accordance with certain embodiments which may for example be operative in conjunction with any of the embodiments illustrated in FIGS. 1-7 and 9-12 or described herein.

FIGS. 9-12 are swim-lane diagrams illustrating example modes of operation, some or all of which may be provided, for the processor of FIG. 7, e.g. in conjunction with the controller of FIG. 1 with which the processor may communicate via Internet as shown or via any other suitable data network and/or in conjunction with a suitable cell app (“application”). The server of FIG. 7 may include any or all of administrative, gateway, web portal, and user management subsystems which may operate in accordance with any or all of the operations illustrated in the diagrams of FIGS. 9-12. It is appreciated that any of the functionalities provided by any of the modes of FIGS. 9-12 may, if desired, be suitably combined with functionalities provided by any of the processes of FIGS. 2-5 and computations detailed in any of the cells of the tables of FIGS. 6a-6e.

Methods and systems included in the scope of the present invention may include some (e.g. any suitable subset) or all of the functional blocks shown in the specifically illustrated implementations by way of example, in any suitable order e.g. as shown.

Computational, functional or logical components described and illustrated herein can be implemented in various forms, for example, as hardware circuits such as but not limited to custom VLSI circuits or gate arrays or programmable hardware devices such as but not limited to FPGAs, or as software program code stored on at least one tangible or intangible computer readable medium and executable by at least one processor, or any suitable combination thereof. A specific functional component may be formed by one particular sequence of software code, or by a plurality of such, which collectively act or behave or act as described herein with reference to the functional component in question. For example, the component may be distributed over several code sequences such as but not limited to objects, procedures, functions, routines and programs and may originate from several computer files which typically operate synergistically.

Each functionality or method herein may be implemented in software, firmware, hardware or any combination thereof. Functionality or operations stipulated as being software-implemented may alternatively be wholly or fully implemented by an equivalent hardware or firmware module and vice-versa. Any logical functionality described herein may be implemented as a real time application if and as appropriate and which may employ any suitable architectural option such as but not limited to FPGA, ASIC or DSP or any suitable combination thereof.

Any hardware component mentioned herein may in fact include either one or more hardware devices e.g. chips, which may be co-located or remote from one another.

Any method described herein is intended to include within the scope of the embodiments of the present invention also any software or computer program performing some or all of the method's operations, including a mobile application, platform or operating system e.g. as stored in a medium, as well as combining the computer program with a hardware device to perform some or all of the operations of the method.

Data can be stored on one or more tangible or intangible computer readable media stored at one or more different locations, different network nodes or different storage devices at a single node or location.

It is appreciated that any computer data storage technology, including any type of storage or memory and any type of computer components and recording media that retain digital data used for computing for an interval of time, and any type of information retention technology, may be used to store the various data provided and employed herein. Suitable computer data storage or information retention apparatus may include apparatus which is primary, secondary, tertiary or off-line; which is of any type or level or amount or category of volatility, differentiation, mutability, accessibility, addressability, capacity, performance and energy use; and which is based on any suitable technologies such as semiconductor, magnetic, optical, paper and others.

### DETAILED DESCRIPTION OF CERTAIN EMBODIMENTS

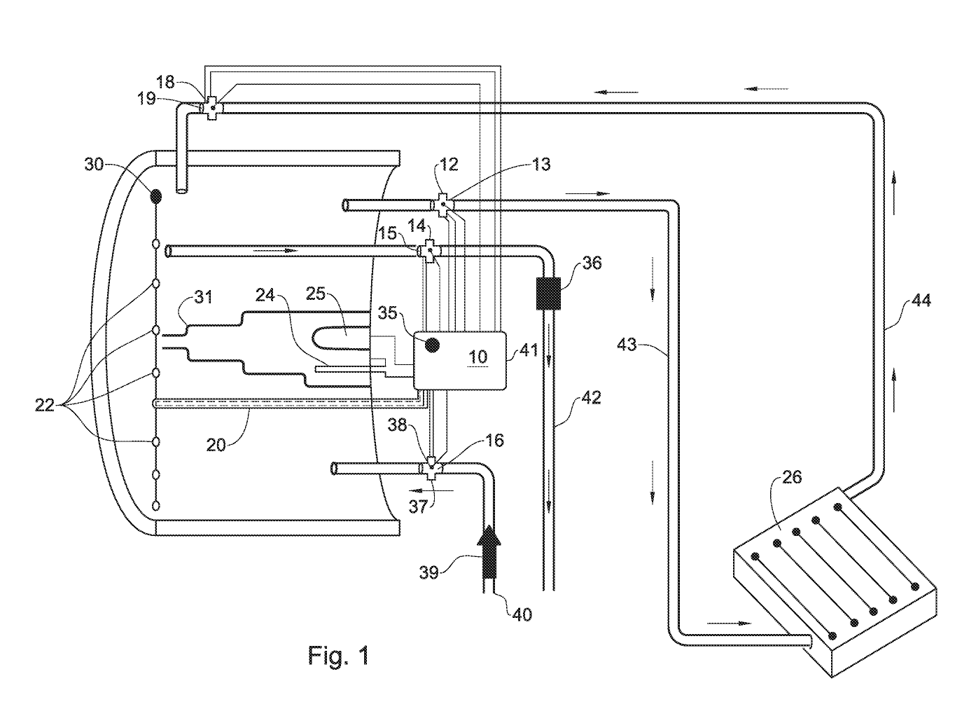

According to certain embodiments, a smart boiler system is provided which may be operative in conjunction with a plurality of boilers. Each individual boiler in the plurality (e.g. the boiler of FIG. 1) may be equipped with at least one sensor monitoring an aspect of the individual boiler's water heating functionality and a local controller collecting data from the sensor and communicating at least some of the data via a data network to a remote server. The controller may include one or more hardware devices e.g. chips, which may be co-located or remote from one another.

The system may include a boiler data repository comprising computer storage operative to maintain at least some of the data, which is accessible by a central server, one or more, in data communication with the data network. The server may have at least one operational mode including a maintenance-needs-detection operational mode which is operative to perform at least one of the following:

a. to scan data stored in said repository, on occasion,

b. to rank, accordingly, said plurality of boilers in terms of at least one predetermined criterion defining at least one maintenance need,

c. to provide at least one “push” output indicating a subset of said plurality of boilers currently ranking high in terms of said at least one predetermined criterion defining at least one maintenance need.

Any suitable criterion may be predetermined to define a given maintenance need. For example, pressure over a level of x may be predetermined as the criterion for a maintenance need, or heating which is x % less efficient relative to a benchmark may be predetermined as the criterion for a maintenance need, or leakage of any magnitude (or of at least x volume per unit time) may be predetermined as the criterion for a maintenance need.

d. To provide manufacturer/distributor/hot water service provider ability to record each consumer's hot water usage.

Reference is now made to FIG. 1 which is an example of a boiler operative in accordance with certain embodiments of the present invention. Alternatively, the boiler may be any conventional smart boiler and/or may have any or all of the properties described in Israel Patent No. 210075, such as but not limited to:

### Example 1

A system for controlling the temperature of water in a hot water installation, comprising:

a. an array of one or more temperature sensors, arranged to measure the water temperature in a water tank;
b. a user interface adapted to receive input from a user;
c. a heating member for heating the water in said water tank; and
d. a control unit adapted to receive information from said sensors array and/or user interface, said unit controls the operation of said heating member,
wherein said system is retrofitted to most hot water installations, adapted to heat a precise amount of water according to the input requested by said user, said system further considers usage profile, for minimizing the heating time and power consumption.

### Example 2

The system according to Example 1, wherein the hot water installation is a solar heating system provided with an electrical backup in the form of an electrical immersion heater disposed within the hot water tank.

### Example 3

The system according to Example 1, further comprising a connector installed between the tank's cold water inlet and cold water supply pipe, said connector encompasses a flow meter and a temperature sensor for sensing flow and temperature of water entering the water tank.

### Example 4

The system according to Example 3, wherein connecting the control unit to the sensors array, user interface, and connector is made via an interface such as but not limited to: USB, wire line, wireless network, cellular interface, Bluetooth, and Ethernet.

### Example 5

The system according to Example 1, wherein the sensors array is positioned in a central location between the wall of the water tank and the heating member, said sensors array measures the water temperature in one or more locations along said water tank to receive a precise measurement.

### Example 6

The system according to any of the examples herein, wherein the sensor array is inserted to the water tank through its cold water inlet.

### Example 7

The system according to Example 1, further comprising a float attached to the sensors array, said float stretches said array along the water tank, for spreading the sensors at equally spaced intervals.

### Example 8

The system according to Example 1, further comprising one or more electronic valves mounted on one or more closed loop pipes entering into the water tank, said electronic valves are connected to the control unit, and are adapted to be closed upon activating the electrical immersion heater for preventing heating the fluid in the closed loop pipes.

### Example 9a

The system according to Example 1, wherein the user interface is installed inside the user's house, typically on the shower room wall.

### Example 9b

The system according to Example 1, wherein the user interface can be presented on any mobile device or PC using web browser or proprietary application.

### Example 10

The system according to Example 1, wherein the input from the user is taken from the group consisting of: number of showers, number of baths, number of dishes, number of piles of dishes, activation timer, shower time, tank's size, and liters of hot water.

### Example 11

The system according to Example 1, wherein the user interface displays information regarding the hot water availability, said information is taken from the group consisting of: number of showers, number of baths, number of dishes, and number of piles of dishes.

### Example 12

The system according to Example 1, wherein the control unit is installed in proximity to said water tank.

### Example 13a

The system according to Example 1, wherein the control unit further comprises a processor for computing the required heating time, and a memory unit for saving data to create a usage profile for future computations.

### Example 14a

The system according to Example 1, wherein the control unit further comprises a processor for computing the difference in water flow in between the relevant inlets and understanding if it is suffering from leakage.

### Example 14b

A boiler which uses a method of controlling the temperature of water in a hot water installation, for minimizing heating time and power consumption, the method comprising:

a. inserting one or more temperature sensors to a water tank;
b. connecting a control unit to a user interface, a tank heating member, and to the temperature sensors;
c. receiving input from a user; and
d. heating a precise amount of water according to the input received by said user, and to temperature sensor measurements.

### Example 15

As in example 14, further saving data to create a usage profile for future computations.

### Example 16

As in Example 14, further configuring the control unit by setting parameters defining the hot water installation, said parameters are taken from the group consisting of: tank size, number of sensors, and sensor location.

### Example 17

As in Example 14, wherein said temperature sensors are inserted to said water tank inside a thin sleeve for isolating said sensors from the water.

Referring again to FIG. 1, water flow meters e.g. 12, 14, 16, 18, are associated with the solar panel circuit. Meter 12 may monitor cold water flowing from the boiler to the collector 26. Meters 14, 16 monitor in-out flow to and from the boiler respectively. The controller 10 may receive information from each flow meter as to the amount of actual flow and the server controller may then deduce if any leakage is occurring between a particular pair of adjacent (in terms of water flow) flow meters. As shown, the primary circuit is augmented by a secondary water path, between (to and from) the solar panel and the boiler. Optionally, an additional circuit/s may be provided e.g. in a central system to accommodate for additional utilities and specific apartments. Optionally, a temperature sensor may be deployed adjacent to flow meter 18 so as to monitor efficiency over time, of the solar panels.

The temperature sensors 22 may be provided, e.g. as a linear array extending along the long dimension of the boiler's interior, to monitor temperatures at plural locations throughout the boiler interior thereby to augment the boiler's legacy thermostat 24 which often comprises a single sensor at a single location within the boiler. The temperature sensors 22 may be introduced into a legacy boiler in any suitable manner e.g.:

a. Through one of a legacy boiler's water inlets, e.g. through the cold water inlet in a standing boiler or through any other entry/inlet depending on the specific setup of the boiler.

b. Through the current thermometer pipeline that is in the boiler itself including possibly replacing the legacy socket.

The array of temperature sensors 22 may be mounted on a rigid elongate member and may be covered with tubing to protect the sensors from water degradation.

For example, assume temperature sensors 22 are to measure temperature at 5 different levels, inside the boiler. For ease of installation in a legacy boiler, the sensors 22 may be arranged, typically at uniform intervals, within a rigid hollow pipe e.g. formed of metal to allow accurate heat conductivity. Sensors 22 may be suitably electrically interconnected e.g. via conductive braided wires. The rigid pipe may be sealed at one end and may define an opening at the pipe's opposite end such that the sensors 22 and associated wiring may be introduced via the opening and pushed into their respective positions along the pipe (say the first sensor adjacent the pipe's closed end, the 2^{nd} sensor ⅖ of the way along the rigid pipe's length, and so forth, with the 5^{th} and last sensor adjacent the open end of the pipe for measuring the temperature at the bottom (say) of the boiler. Once the sensors are installed, the open end of the pipe is suitably sealed. The pipe may then be introduced into the boiler e.g. through a splitter connected to the cold water exit connecting the boiler to collectors 26. Once the pipe is in the boiler, the splitter may be screwed in and the water outlet sealed.

A cold water temperature sensor 13 may be deployed e.g. as shown, to monitor temperature of water exiting the boiler and flowing to the collectors 26. A hot water temperature sensor 15 may be deployed e.g. as shown, to monitor temperature of water exiting the boiler toward the household piping system. A hot water temperature sensor 19 may be deployed e.g. as shown, to monitor temperature of water exiting the collectors 26 and flowing to the boiler of FIG. 1.

In each active water inlet or channel, a water flow sensor and/or temperature sensor may be deployed in order to detect water flow in a resolution that may be defined per customer and specific boiler setup (e.g. 0.5 L/H) and/or to detect the water temperature in the inlet itself. The sensor installed may be deployed so as not to interfere with the water flow in the inlet itself. For example, temperature sensor/s may be deployed only in the solar panel circuit to assess that circuit's efficiency over time.

Water flow sensor readings may be used by the central server for any or all of:
1. Detecting and typically diagnosing location of leakage in the boiler, including in related equipment such as solar panels 26 in FIG. 1.
2. Detecting the temperature of the water arriving from the solar panel and determining degradation of solar panel heating efficacy over time (e.g. due to dust on the panels). Comparisons to other consumers in the same geographical area may be used to determine whether or not solar panel maintenance replacement can contribute to electricity saving since all consumers in the same geographical area enjoy the same number of sunny days. The water flow 18 can also help in detecting blockage due to calcium accumulation which is extremely common, yet remains undetected in state of the art boilers.
3. Detecting the amount of water entering/existing the boiler and used by the consumer e.g. via water meter 14 which monitors the flow of hot water exiting the boiler.
4. Detect cases where a specific inlet is blocked by comparing readings in water flow meters deployed upstream of a specific inlet, and downstream thereof.

The temperature sensors 22 and the various water flow meters are typically both connected to a controller that may be mounted on the boiler of FIG. 1 itself or in the boiler's vicinity e.g. within the same household to simplify sensor-controller connectivity which may then be based on direct physical wire connection, as well as USB, RS232, Wi-Fi, ZigBee, Bluetooth, RF, SPI, 12C, UART, 12S, PWM, ADC, DAC or other.

Controller 10 is typically operative to track the state of each connected sensor (e.g. boiler interior temperature sensors 22, pressure sensor 30, pressure and temperature sensors 37 and 38 respectively, monitoring the point of entry 39 of cold water into the boiler, etc.) to support basic computations required to support local action which it is desired to provide without central server involvement. Controller 10 may be associated with a suitable switching unit and communication unit which may be packaged for simplicity in a single housing 41. In parallel, the sensor state is transmitted to the cloud (or actual central server farm), typically allowing states to be tracked even in case of cloud-boiler connectivity loss for an extended period of time. The controller 10 may be connected directly or wirelessly e.g. via Wi-Fi, RF, ZigBee, Bluetooth, Ethernet or other suitable technology to the Internet directly or through provided consumer router.

The boiler switch may be a simple on-off switch. Alternatively, the boiler switch may include a graphical interface to display information and support more extensive system configuration then mere on-off.

Any suitable “distribution of functionality” may be used between the switch and the mobile/web application such as no app, all functionality on the switch, or strictly limited switch functionality, extensive app functionality.

An on-off switch governing operation of the boiler's heating element 25 may present advanced graphical representation of the water temperature, number of showers available, water quantity above temp limit, operational status such as on-off and operational status etc. The switch may be connected to the boiler controller directly e.g. via a wired electricity line, Wi-Fi, RF, ZigBee, Bluetooth, Ethernet or any other suitable communication technology.

It is appreciated that any suitable set of sensors may be deployed within or around the sensor of FIG. 1 and the specific sensors shown in FIG. 1 are merely by way of example. For example, any suitable number of or orientation of internal temperature sensors 22 may be provided. Any suitable number of flow meters such as but not limited to any or all of illustrated flow meters 12, 14, 16, 18 may be provided, at any suitable location. An external temperature sensor e.g. sensor 35 in FIG. 1, may or may not be provided. A solar panel temperature sensor may or may not be provided. The sensor 30 sensing the boiler's internal pressure may be positioned in any suitable position such as but not limited to the position shown, and so forth. Wiring to/from various temperature and/or pressure sensors and the controller 10 may be provided interiorly of a hollow pole 20 designed to protect temperature and pressure sensors and suitably positioned e.g. as shown.

Controller 10, co-located with the boiler rather than with the central server, typically constitutes the first logical layer in the system. The controller may be installed on any suitable operating system (OS) such as Android, Arduino, different Linux flavor or other PCB (printed circuit board). A code that authorizes connectivity to the central server's IoT (Internet of Things) platform may be assigned e.g. during installation and may transfer the relevant data from this specific boiler to the central server's cloud service. The controller may have a hardcoded identity key to identify itself. During the setup phase this key may be assigned by the central server to the installed system e.g. as described in the example flows herein. Another code may optionally be assigned during this phase that may operate in parallel, to implement higher security capabilities.

The central server may include a cloud platform comprising a plurality of servers which may include a plurality of logical layers e.g.:

Front end: e.g. filtering unknown, unauthorized or illegal requests for service/authentication and authorization

Back-end: some or all of data store, rules engine, analytic engine e.g. as described herein, and peripheral services such as but not limited to e-mail or other communication modalities to end-users (boiler owners), alert and monitoring.

Registration may include warranty activation which may be electronic. For example, during installation, the technician may set up the system with all relevant information e.g. as described herein, may connect the sensors to the controller and may connect the system to the Internet, including enabling logging in to the central server's cloud service by facilitating the setup with relevant login credential. Once this installation process has been completed, the end-user (boiler owner e.g.) may be able to perform any or all of: log on to an end-user operational web site and see her or his own particulars including warranty particulars, manage his boiler setup and download a mobile app allowing some or all control functionalities to be performed remotely via the end-user's cellular phone.

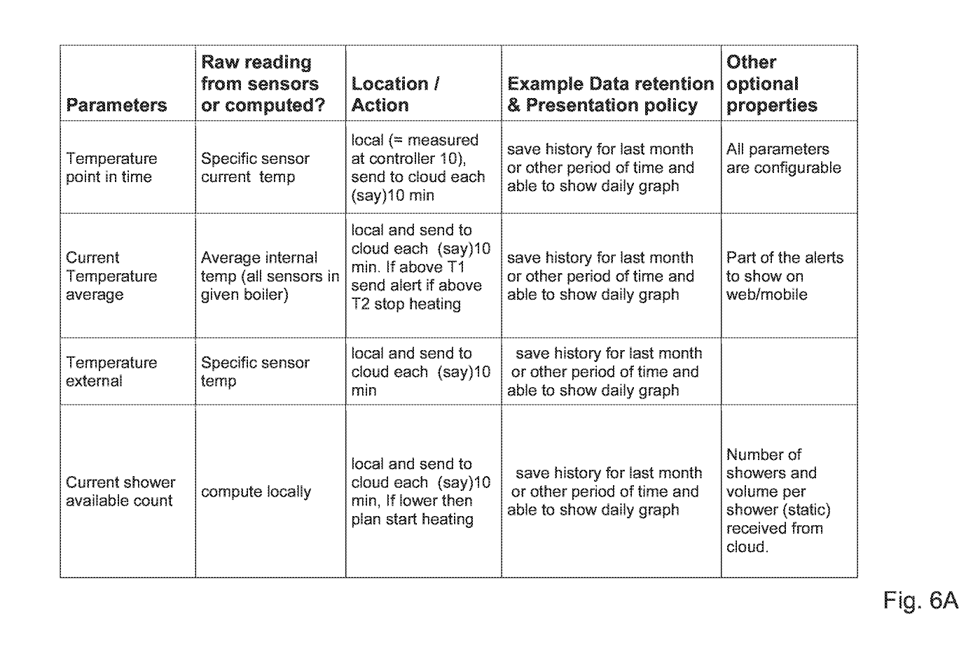

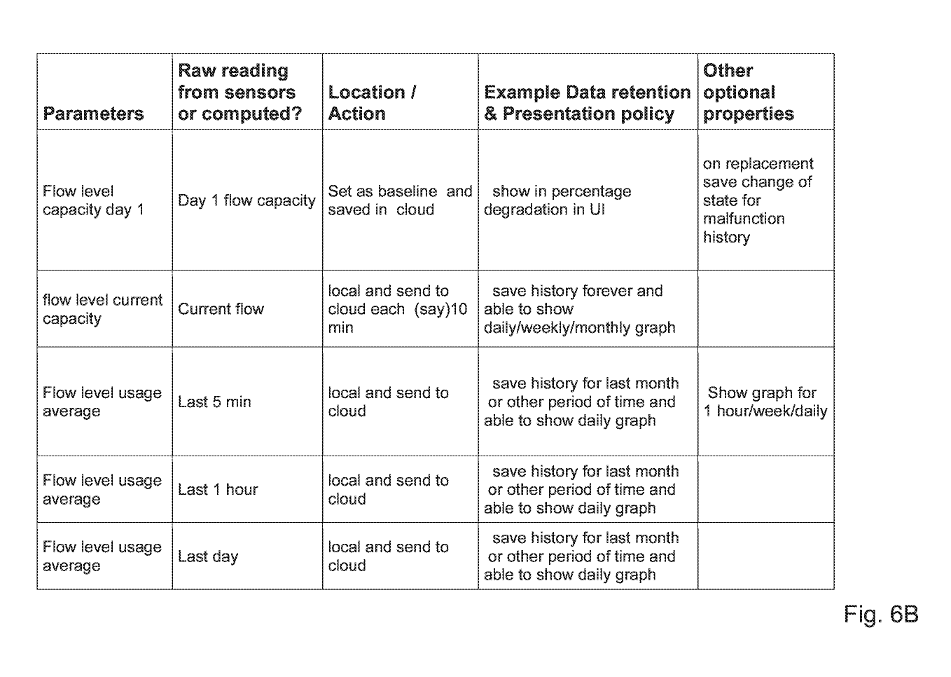

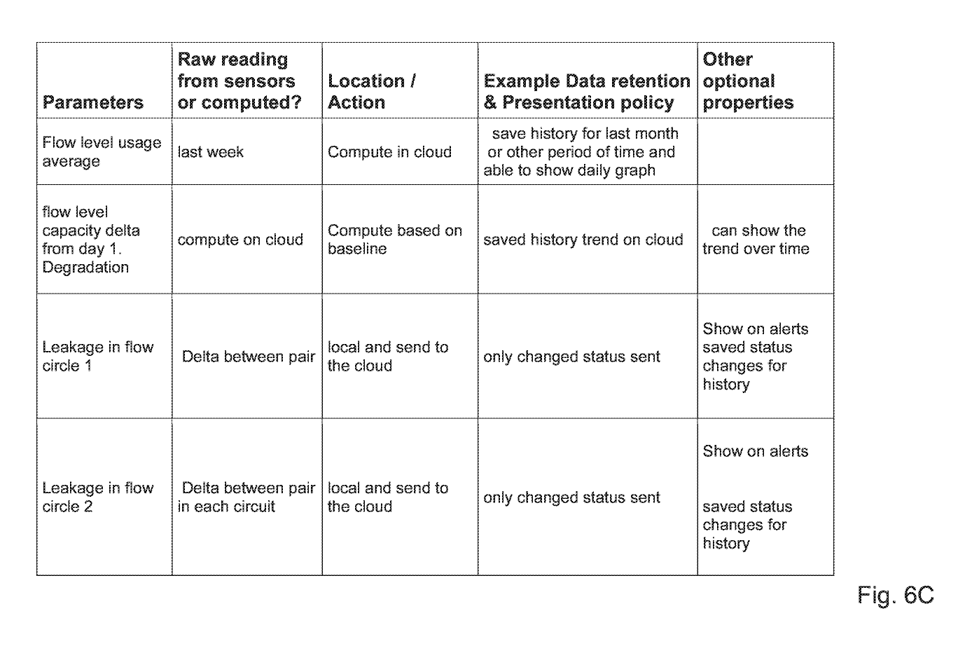

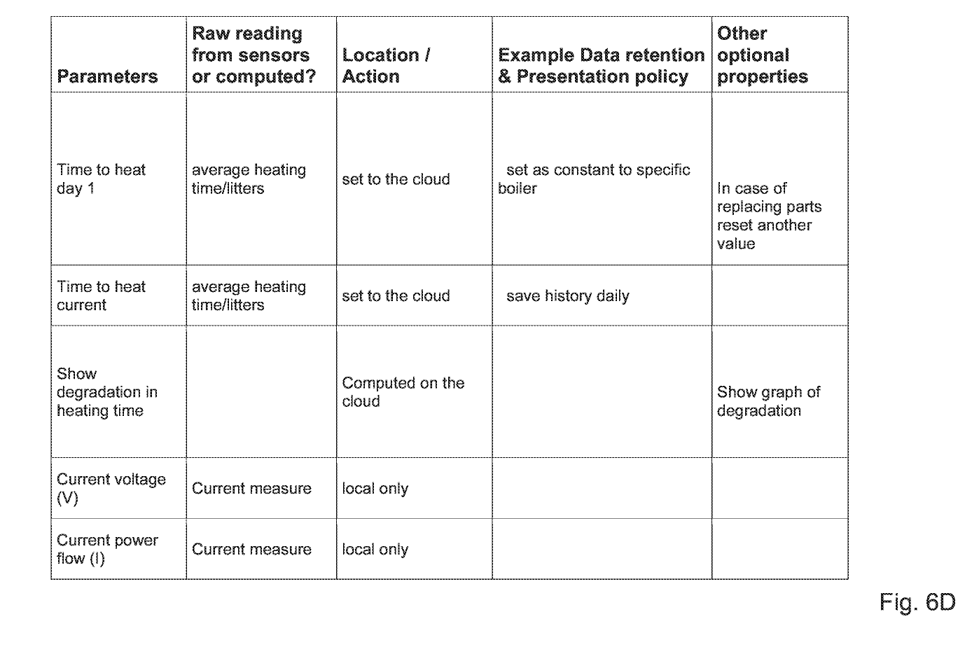

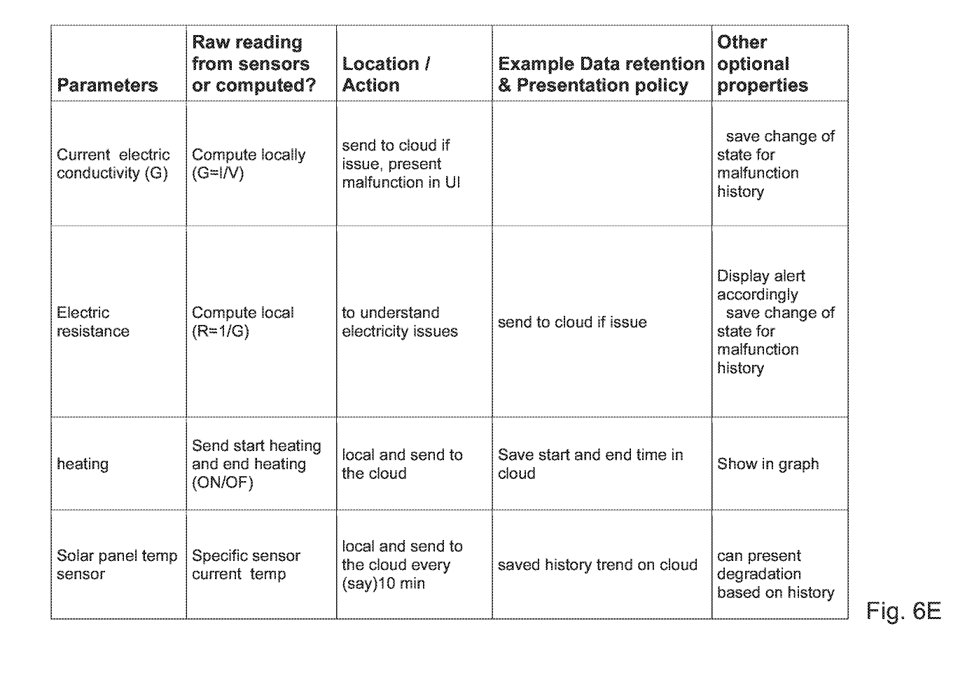

Following installation, the manufacturer may see an additional operational boiler on a manufacturer's operational portal provided by the central server, typically along with some or all of the following boiler current properties: operational status, usage information, system location, system malfunctions etc. e.g. any subset of or all of the parameters shown herein in the table of FIGS. 6a-6f.

The installation technician typically is provided, by the central server, with her or his own operational portal that may present all systems (networked boilers) installed by her or him giving him access to consumer status as well.

The system utilizes the data derived from the sensor/s to detect malfunctions in the boiler system. Data collected from or derived by the controller from the sensors in FIG. 1 may be subjected to analytics on the central server e.g. cloud backend system and may for example quantify on occasion, or track, physical deterioration of each boiler with usage over time.

According to certain embodiments, any or all of the following boiler conditions may be detected e.g. locally by the controller:

Water leakage from the boiler: Flow meters installed in each water intake may transfer the data to the local controller 10 which may compute locally the total input/output and/or determine if there is any leakage in the boiler itself. In case of leakage, the central server may send notification commanding the controller to cease the heating process.

Power failure: Typically, the controller 10 is connected to the house power source, to the sensors and to the home on-off switch. The controller can determine, based on inputs received thereby, whether there is any power failure in one of the segments e.g. in the segment extending from the electricity circuit to the boiler from the main electricity panel, vs. malfunction at the switch itself.

Network connectivity failure: The controller can perform network connectivity checks that can determine if there is a network connectivity issue and in which network segment there is an issue, where network segments may, for example, include any or all of: in house network connectivity, network connectivity to sensors, network connectivity to on-off switch, network connectivity to cloud services.

Temperature limits: The system and indeed even the legacy boiler may detect if the temperature is rising above a predefined threshold that triggers warnings to the consumer and/or automatic discontinuation of the heating process e.g. by the controller.

Heating efficiency/physical deterioration: The controller may send data quantifying any or all of: temperature measurements, heating time period, solar collector's (panels) water temperature to the central server's analytics engine. The analytics engine may accumulate historical measurements e.g. for a predetermined window of time and may provide measurements or statistics derived computationally therefrom, to the consumer and/or manufacturer. This data may be used to derive physical deterioration parameters computationally and may enable the central server to provide at least one output proactively alerting about an upcoming maintenance need, at appropriate time/s. Another factor that may be sent from controller to central server is the geographical location and/or the setup of solar collector 26 of FIG. 1 e.g. number of solar panels for a shared solar setup serving several end-users, direction of the panels for sun collecting efficiency, type of panels, installation date e.g. unless new, etc. The central server may use this data to fuel analysis of power consumption per geographical location, heating time/electricity cost, estimation of the “state of health” of the solar collectors and so forth, all in accordance with suitable logic typically defined at the central server's analytics engine.

Water flow issue/physical deterioration: flow meter data and analysis of history usage patterns may be used to determine if there is any deterioration in the water flow through any one of the water channels associated with the boiler, and facilitate maintenance in case of need.

The central server may include a Back End/Front End Cloud Layer architecture. The server/cloud may communicate with the controller e.g. on a regular basis such as once every few minutes—say once per 2 or 5 or 10 or 30 minutes. Each communication may be authenticated to a specific installed boiler. The communication may be bi-directional and may support data transfer and execution commands. After authentication, the transferred records may be saved to the system's data repository. Saved records may be stored in a data object available aka accessible for rule analysis triggering actions, and analytics procedures to present malfunction and monitor physical deterioration, customer usage patterns, and cost efficiency models. A presentation layer may be provided, presenting boiler location and boiler data.

The front-end may support relevant industry protocols like MQTT, HTTP 1.1 so the controller can take advantage of alternative protocols even if the cloud backend does not “speak” these protocols. The front-end can scale to accommodate billions of responsive long-lived connections between controller and cloud applications. The controller 10 can publish its state (e.g. functional/malfunctional/levels of usage etc.) and can also subscribe to incoming messages from the central server. In the back-end cloud layer a real-time rules engine may be operative to transform messages from local controllers based on predefined logical and/or computational expressions, and may route the transformed messages to the data repository for additional compution. (e.g. get from controller the amount of time heating was on, in order to provide hot water for four showers). The additional computation may determine the amount of heating time needed over time to identify deterioration of heating system capabilities and optionally to compute the extra cost engendered. Routing may be driven by the content and/or context of individual messages. For example, routine readings from a temperature sensor could be tracked in a database table and if a reading exceeds a pre-stored threshold value, relevant action/s or function/s may be triggered e.g. as described herein.

Any suitable presentation layer may be provided. For example, the presentation layer may provide some or all of the following operational websites:

1. Consumer (aka boiler end-user) site may present all relevant system data such as but not limited to some or all of: boiler model, type of installation such as but not limited to private installation vs. central building, only new boiler or only new solar panels, inside a house vs. externally to the house etc., date of manufacture, date of installation, overall usage counters, kind of warranty and date, geographical location and address, consumer name, phone numbers, download link to mobile application. A boiler end-user mobile application may have some or all of the capabilities aka functionalities, as the consumer web site. Using her or his site, the consumer may operate the system whether or not he is physically adjacent to the boiler, e.g. utilizing features provided by the analytic engine as described herein.
2. Manufacturer site may include a geographical map portraying installed boilers. Search capabilities may be provided for identifying consumers/boilers based on parameters such as but not limited to any of the following individually or in combination: manufacture date, serial numbers, consumer name, geo location/address, installing technician, phone number, operation status. The manufacturer uses this site to see all relevant data per particular boiler/s including specific installed system to see operational status and events. The manufacturer (aka manufacturer end user) is typically able to export registration information to the manufacturer back office system. Visual aids may be provided e.g. fully operational boilers marked green, degraded systems marked yellow and malfunctioning system marked red. Notification per status may be sent to the manufacturer for further investigation and for initiating proactive technical support for an individual consumer. A manufacturer may have the ability on her or his site to assign a specific consumer to a specific channel/technician in her or his maintenance workforce.
3. Installing technician/channel website for each individual in the boiler maintenance workforce. This site typically shows only partial consumer relevant operational/contact information, relative to what is shown to the manufacturer with whom this technician is associated.

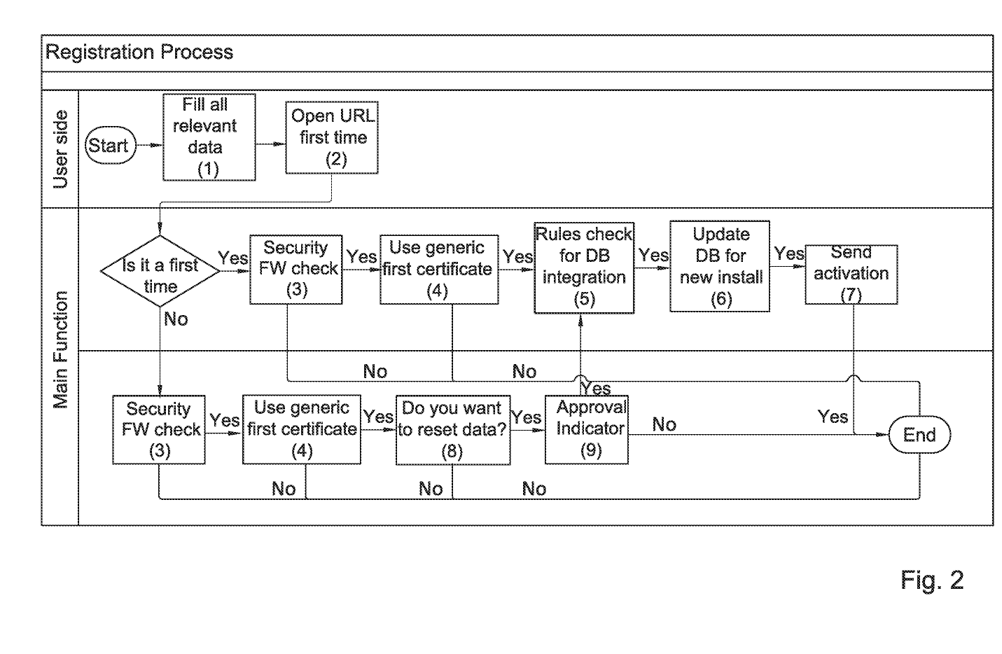

A suitable registration process or service is now described with reference to FIG. 2. Typically, when a new device e.g. boiler is added to the system, a generic working procedure is used that includes a first generic registration service with a specific generic authentication credential and procedure that, upon completion, overrides the boiler controller settings with a new set of relevant settings and specific credentials that may serve as ongoing boiler controller settings. This feature supports remotely managing the device.

The registration process may include some or all of the following operations, suitably ordered e.g. as follows:

Operation 1. When the boiler is delivered to the consumer, an engineer, aka member of the workforce may, either at the manufacturing premises or at the consumer's home, set relevant parameters on the boiler controller e.g. using her or his browser/mobile application. This may be done either via direct connection to the controller, RF, Wi-Fi, IR, Bluetooth, ZigBee or other.

The default setting on the controller may include some or all of:

a. Default URL directing to the activation process shown and described herein.

b. X.509 certification or equivalent

c. Consumer registration data

d. Installer/Engineer credential

e. Other product relevant information

Operation 2. Upon provision of all data defined as mandatory, a submit button may become visible. The above data may be sent to a pre-set embedded URL that may be overridden by an ongoing service URL upon successfully completing an activation process e.g. that is shown and described herein. This pre-set embedded URL can be edited by a technician on site, or a remote assistant in case of factory reset and need.

Operation 3. Each first authentication may include a decryption procedure utilizing the generic “first timer” certification that is pre-set and imbedded in the controller. This certification URL can be edited by a technician on site or a remote assistant in case of need.

Operation 4. Following decryption of a boiler registration request from a boiler end user, the server (say, cloud service provided thereby) may determine whether or not the request is legitimate by comparing the request with approved patterns and may deny the request e.g. based on relevant patterns. With first stage approval of the pattern as legitimate, authentication based on engineer data may be conducted.

Operation 5. The service may evaluate if the request for boiler registration is indeed the first such request for this boiler, and may ask whether to reset values. In case of reset, manual manager approval may be required.

Operation 6. For a first time registration request, all relevant information should be introduced to the DB (aka data repository) and new registration and authentication data should be sent back e.g. with additional information such as firmware upgrade or other. This supports communication of the central server with the end device thereby to remotely manage the boiler's functionality.

Operation 7. All relevant data may be sent back to the controller 10 and a process that may check functionality after setting of all new values (e.g. its controller self-check and/or controller check against the server). Subsequently, an SMS, email or other may be sent to the consumer with initiation/activation/mobile application download links.

Operation 8. If the service reveals that the boiler already was registered in the past, a message may be presented to the technician asking if he want to reset the controller. This can be done remotely.

Operation 9. Even after technician approval, higher approval may be required depending on working procedures preprogrammed by or for the manufacturer. Upon receipt of approval/authorization, a full data reset may be performed, but previous information may be stored in the data repository for history purposes if so mandated by a default or manufacturer-predetermined data retention policy.

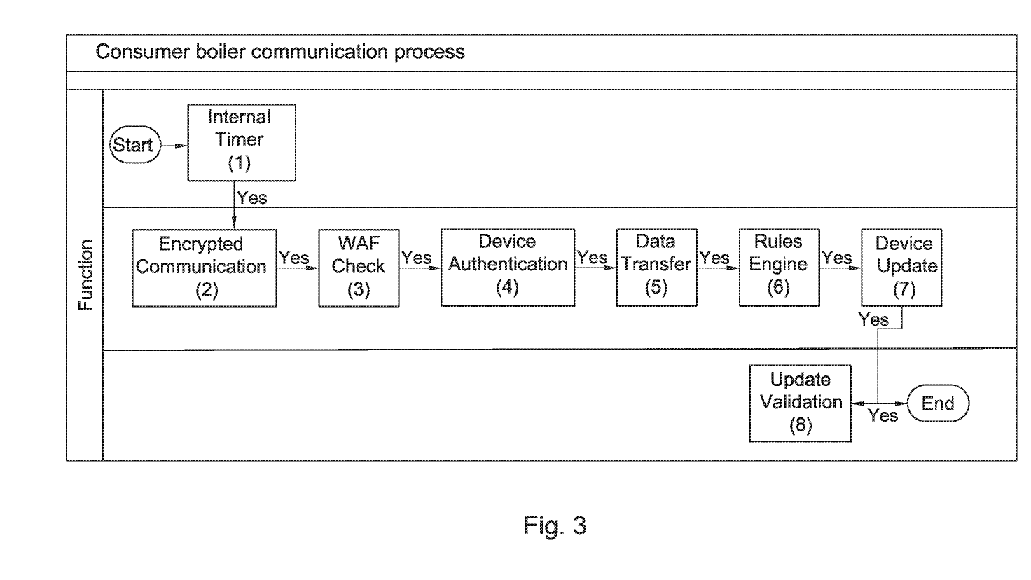

An example Boiler-to-cloud communication process is now described with reference to FIG. 3. This procedure may govern normal boiler to cloud day-to-day operation, and may include some or all of the following operations, suitably ordered e.g. as follows:

1. The boiler controller invokes, e.g. responsive to an internal local timer, a request to the central server. The logic that is set on the controller may stipulate that each and every X min a request is to be conveyed to the central server. If service is not available, a sleep timer may be set for X+Y minutes where Y's value increases over time. This mechanism may eliminate denial-of-service (DOS) or impact on the system shown and described herein in case of internal malfunction or network issues and/or may eliminate load when recovering from server/cloud malfunction.

2. Communication may be encrypted and decrypted e.g. using a stored certificate on the controller and on the central server's front-end. Mechanism replacing this certification may enable the central server to update certificates with time limits.

3. Validation: After decryption, the request may be matched with a white listed pattern on the service front-end, and may pass only those requests for device authentication which are approved and legitimate.

4. If validation is successful, the device itself may be authenticated.

5. Data objects may then be uploaded to the cloud.

6. Each uploaded data object may be validated against rules and old data, for example: rule may validate if immediate action is needed to be set:

a. Is boiler status/health ok—if not, change boiler status

b. Is any immediate action needed—e.g. turning off the boiler

c. Is there any communication needing to be set

d. Is there a need for a device update

7. If device update is needed, a relevant message may be sent to the controller with updated data and action needed. e.g. reset learning profile and get back to usage learning state if a boiler previously serving end user x, is now serving end user y (who may be a new tenant replacing x who was the previous tenant). In some cases, the data may override the current setting, and in other cases e.g. firmware update, an indication may be set for manual approval based on settings on the device. An automatic update may be available if the controller was set for receiving automatic updates.

8. After any change in setting, a new communication request for immediate validation may be sent by the controller to the central server.

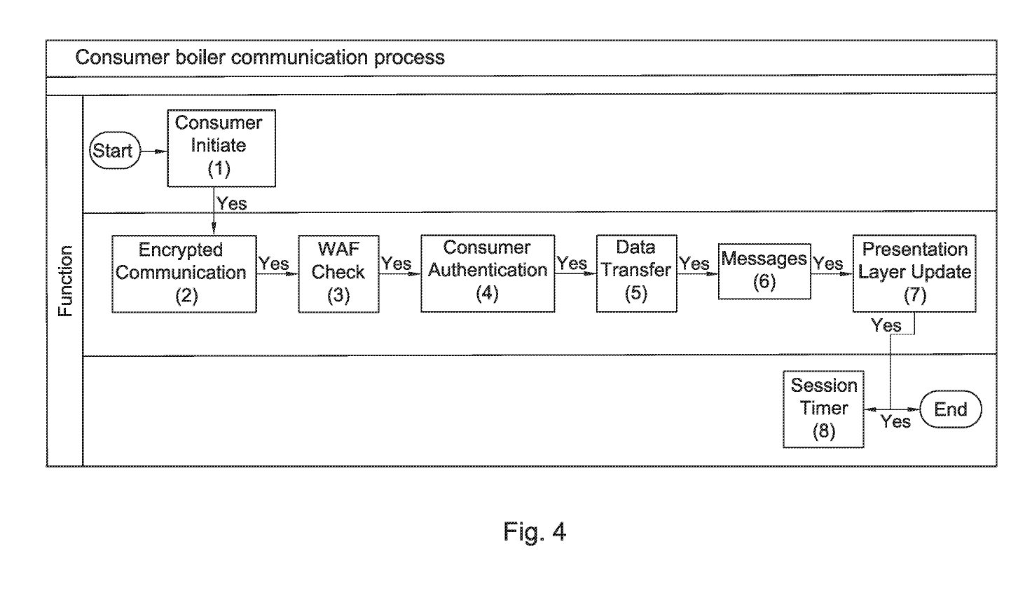

An example consumer boiler communication process is now described with reference to FIG. 4. Consumer communication to the boiler controller from mobile or web application is typically through the central server described herein. The consumer is typically able to operate her or his boiler locally only from the on-off switch at home and, according to one embodiment, only for “basic operation” e.g. only for a predefined set of basic operations, whereas various advanced options are available only via the central server and associated consumer site. The consumer boiler communication process may include some or all of the following operations, suitably ordered e.g. as follows:

1. URL and certification may be stored locally on the device for immediate authentication. Additional username/password may be needed, or only password, if communication is from a mobile device.
2. Validating legitimacy of the requested URL against white list pattern may occur immediately after decryption. Upon approval (e.g. after frontend server approval process determining that the request is legitimate e.g. as described below), the authentication is deemed to have been completed. Typically, after decryption, the request may be matched with a white listed pattern on the service front-end so as to pass only those requests for device authentication which are approved and legitimate.
3. Following authentication of the user, a set of policies may be attached to that user in the central server's data repository, so as to enable his actions. For example, perhaps only home user (aka boiler end user) and not a technician, may be able to add additional family members; but only an approved technician (aka member of the maintenance work force) but not a family member can reset the boiler to factory setting.
4. Responsive to a first request the mobile/web application ask for data to present. Typically, only a relevant delta may be forwarded for presentation—for communication optimization. Data may be encrypted and compressed.
5. Following data transfer to the consumer presentation either on mobile or web application, Indication for new messages or alerts may be available for immediate action or knowledge. For example a message may show that boiler leakage has been detected and within the message a virtual button may appear, for calling a maintenance technician. More generally, any input option may appear, typically within the message, to support immediate action being initiated from the message itself.
6. When all relevant data has been updated in the consumer application, the consumer may be able to initiate supported actions such as but not limited to asking the manufacturer to contact him, or changing heating method policy (for example if it is desired to move from manual mode to the adaptive mode or to set boiler operation to accommodate for availability of water for 4 showers instead of 2, or, if the consumer aka end user, is going on vacation hence has no need for heating time, switch on-off heating).
7. X (configurable parameter) minutes after the session becomes idle, the session may be terminated.

Another method allowing the consumer to communicate with the boiler automatically involves setting a calendar in the consumer's profile that the central server can access. The central server may read specific events in the consumer's calendar to determine whether the consumer is away from his house or alternatively is at home and is either alone or has visitors staying with him. The heating schedule setting may then be changed accordingly. When the “away” parameter (indicating consumer is not in his home) is set, boiler may not expend power for heating, and instead may have warm water waiting for the consumer at the known time of his return. If additional visitors are staying, the central server may compute the amount of warm water needed and timing thereof, and these changes are applied only during the visit and not introduced to the normal usage pattern for this consumer.

Cloud boiler communication process: The central server e.g. cloud service typically has the ability to initiate communication directly to the boiler for management and operation purposes. This facilitates automatically changing the behavior of the boiler when severe boiler malfunction is detected, as well as changing heating time based on consumer behavior learned by any suitable central server algorithm, or based on changes in electricity cost and demands which become known to the central server e.g. from external sources. The cloud communication process may for example be an ad-hoc communication process performed in case of need that was analysed on the server/cloud side, or may be based on specific consumer request/s rather than on a periodical process.

### Changes in Consumer Usage Pattern

1. Detection of abnormality in regular usage patterns learned by the central server for an individual boiler user, that are indicative, based on predetermined logic at the central server, of leakage, overheating, high boiler pressure, changes in electricity cost on specific time of day, setting consumer away policy etc.
2. Changes to the override parameters setup for example increase in number of resident family members, number of showers desired, change in shower time table, etc.

The working cloud boiler communication procedure may include some or all of the following operations, suitably ordered e.g. as follows:

a. Validate relevant boiler or boilers
b. Presenting action to be done e.g. on screens of technician interface or end user interface, and approval thereof by predetermined users such as technician, end user, both, etc.
c. Automated action to be done without approval based on predetermined policy
d. Getting acknowledgement: after each change initiated from the server side and performed on the controller, a self-check that the change was successfully made, may be performed on the controller and communicated to the server for acknowledgement. Then, log the session to the data repository, and end session.

### Server-Consumer Communication:

Any or all of the following technologies for communicating to the end consumer may be supported:
1. SMS sent in case of alarm to predefined cell phone numbers stored at the data repository for each boiler user
2. Alert/message shown on the mobile/web application
3. E-mail sent to consumer
   The server may include logic for selecting one or more of the above, based on the severity and urgency of the event to be communicated e.g. SMS for critical issues only. Critical and ongoing issues are also tracked in the mobile/web message inbox. Consumer usage and suggested saving are sent periodically, e.g. monthly, to the user e-mail address.

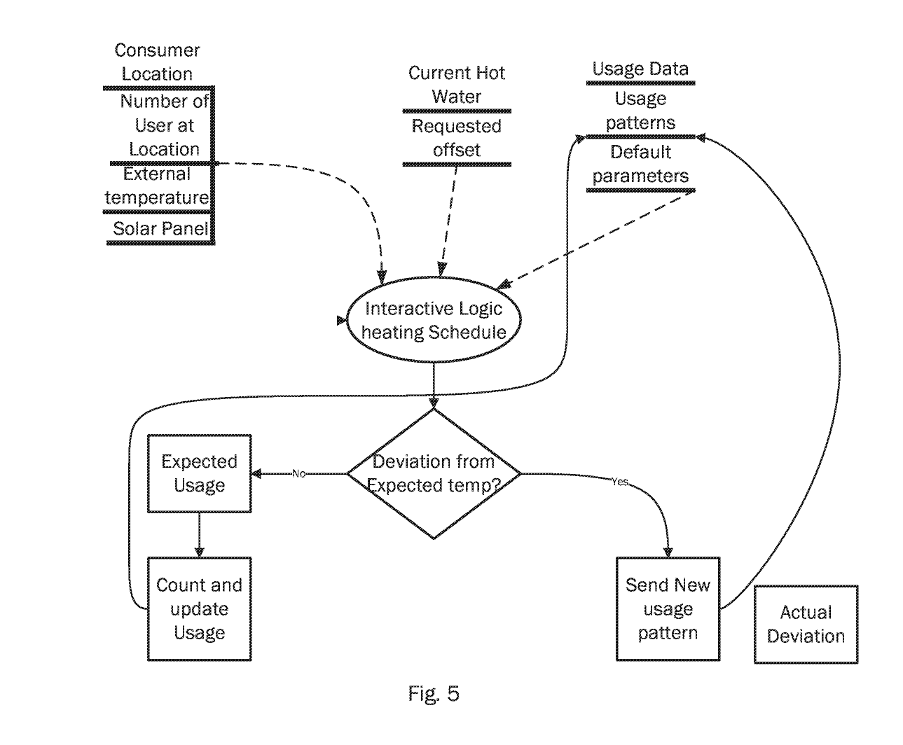

The central server typically includes an analytic engine such as that shown in the block diagram of FIG. 5. The analytic engine may use a cloud service to develop user behavior and boiler understanding, using data collected from the various sensors as well as consumer usage data learned therefrom e.g. by suitable averaging of historical water usage data for a given consumer. Using any suitable learning technology, the central server's analytics engine may develop an understanding of consumer behaviour and/or of her or his boiler's current and past efficiency (e.g. thermal efficiency and/or overall boiler efficiency) and general status (e.g. physical deterioration over time). Based on this understanding, messages may be fed to the consumer, manufacturer and boiler that may translate to activities.

Any suitable predefined e.g. learned logic may be employed by the central server to translate individual consumer behaviour into heating needs and consequent commands to the local controller serving that individual consumer.

The interactive logic heating schedule output typically comprises a user profile that can be compared to profiles stored at the data repository for other consumers. The usage pattern may be normalized by the central server for various populations defined e.g. per geographical area, per region of ambient temperature, per age of boiler (or of consumer), number of users in the house, gender or other relevant end user parameters. Using these population norms the central server may compare the specific consumer usage e.g. to other boilers. Serving users that are in the same geographical area can yield knowledge as to the current consumer boiler status and facilitate computation of heating usage time for the specific consumer need and/or determine a suitable heating usage pattern to facilitate cost saving.

Boiler heating efficiency may be computed as a function of heating system power, boiler capacity (in liters e.g.), ambient temperature of the region in which the boiler is situated, and the rise in temperature achieved by the boiler's heating element 25 per unit time, relative to the current water temperature (e.g. degrees per hour). For example, the boiler heating efficiency may be computed as the product of heating system power, ambient temperature, and rise in temperature per unit time, divided by boiler capacity.

The central server may also learn per specific boiler any or all of the following: The actual water heat lost per unit time and solar panel water temperature, thereby to determine actual physical degradation. By collecting these factors over time and comparing them to the same factors stored for that specific boiler just after it entered operation (just after installation) and/or comparing these factors to the same factors stored for other boilers e.g. in the same geographical area. Data may be normalized e.g. by creating a scale of boiler efficiency so as to adjust for boilers not located at the same geographical region hence experiencing a different climate, say by using external weather reports and each boiler's known geographic location, to generate a base line for comparison e.g. between different boiler manufactures, boiler types and models, and boilers with different year of manufacture.

Based on the normalized BHE (Boiler Heating Efficiency), the central server may create a scale of 1-10 that may be used to quantify cost impact on electricity needed to heat the water. Data defined along this scale can help determine if boiler replacement is warranted in terms of cost efficiency.

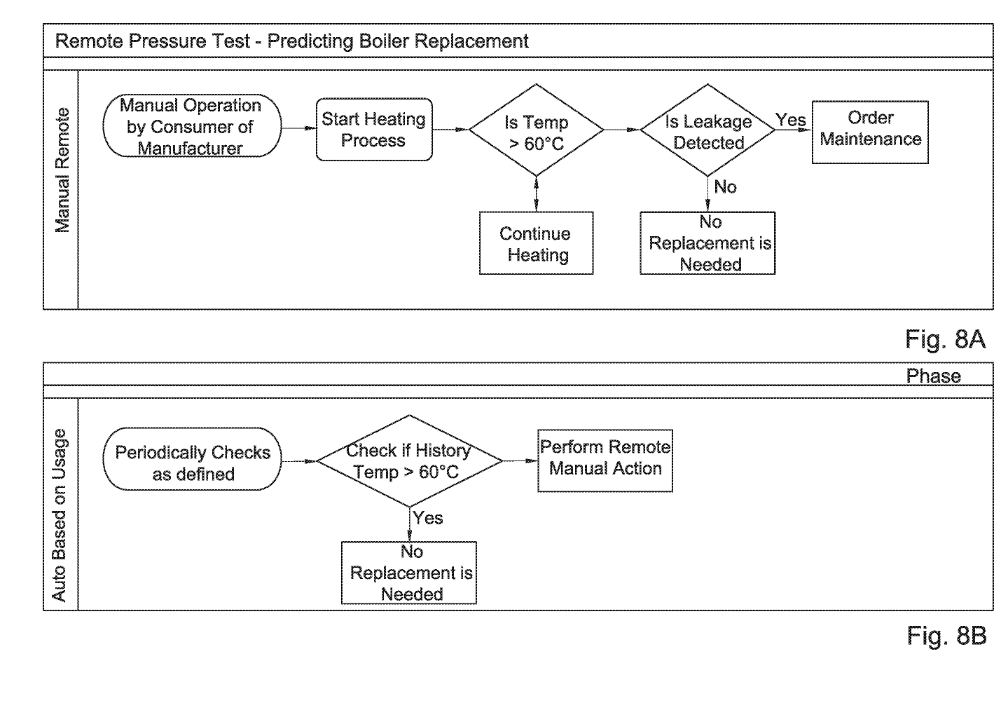

FIGS. 8a, 8b are simplified diagrams of boiler maintenance/replacement need prediction flow, which may be based on a remote pressure test and which are provided in accordance with certain embodiments which may for example be operative in conjunction with any of the embodiments illustrated in FIGS. 1-7 and 9-12 or described herein. The flow of FIG. 8a is a manual remote process whereas the flow of FIG. 8b is an auto-process based on actual usage which may be performed on occasion, e.g. periodically. The flow/s of FIGS. 8a and/or 8b support predicting whether or not replacement of a boiler is needed, e.g. based on historical temperature data. If high temperature has not been reached, the controller may be commanded by the central server to start heating for testing. If the temperature is above a threshold temperature e.g. 60 degrees C. and at that time no leakage was detected, no replacement is needed. However, if leakage is detected at high pressure, replacement may be initiated e.g. by defining a suitable maintenance need criterion. It is appreciated that high temperature may be used as an indicator of high pressure and/or high pressure may be directly detected by deploying a pressure sensor in the tank. Normally the boiler can operate at low pressure, especially in summer periods when no power is needed for heating. A remote test can be performed to determine whether or not maintenance/replacement is to be expected upon commencement of an upcoming period of high pressure. If so, a suitable “boiler replacement expected, come winter” maintenance need criterion may be defined e.g. to enable an off-season maintenance visit to pre-empt boiler failure and a need for a rush maintenance visit during peak season.

According to certain embodiments, any or all of the following failure detection/handling functionality is provided:

Thermostat failure detection—to prevent subsequent boiler explosion. Typically, a boiler's thermostat is set to turn off the heating system once the temperature reaches a predetermined threshold e.g. 60 degrees C. If the thermostat is dead, the heating element (25 in FIG. 1) keeps working which may cause the boiler to explode as pressure builds due to the temperature going higher and higher. According to certain embodiments, temperature sensors in the boiler, which are redundant to the thermostat's own temperature sensors, measure the temperature in the boiler. Then, if the water around the thermostat exceeds the known 60 degree limit by at least a predetermined amount, an alert is generated. As described herein, this test may be conducted proactively e.g. periodically during times of the year in solar collectors (26 in FIG. 1) which heat the water to very high temperatures. The central server may, for this proactive test, command the controller to turn the boiler's heating element/s on, to check whether the thermostat succeeds in stopping the heating once the water temperature exceeds the known limit. Any failure to do so is deemed a maintenance need criterion.

Explosion heads up: If the thermostat intended to prevent over heating is found to have failed, e.g. as above, a pressure regulator (36 in FIG. 1) may open slightly e.g. responsive to a central server command triggered by the detected thermostat failure, to enable water to exit the tank thereby to drive the pressure down and prevent explosion.

Failure Detection Based on Pressure Regulator Monitoring:

Being mechanical, pressure regulators are prone to failure. Once the pressure goes high (e.g. in summer where the temp may be high due to particularly successful operation of collectors 26), the regulator is charged with releasing water from the tank to reduce pressure therein. According to certain embodiments, pressure regulator operation is monitored. This is because release of water is detected by suitably placed flow meters e.g. as shown in FIG. 1. Typically, some or all of the water flow channels in FIG. 1 are each separately monitored by a meter e.g. some or all of: the cold water flow to the solar panel 26 via cold water pipe 43 connecting boiler to collectors, the hot water flow from the solar panel 26 to the boiler via hot water pipe 44 connecting collectors to the boiler, the cold water flow into the boiler via main water entry point 40, the flow of water from the boiler to the household pipe system, via hot water pipe 42, for household use. In particular, water may be detected coming in (through the inlet flow meter) and no water is detected going out through the outlet flow meter. This may be interpreted as meaning either a leakage event, which warrants maintenance to fix the leak, or a thermostat malfunction event, which also warrants maintenance, since operation of the pressure regulator indicates that the thermostat is not functioning properly, mainly during winter periods with few or no sunny days.

Detection of High Risk of Explosion:

Criteria for this critical maintenance need may include some or all of (a, b and c) the following:

a. temperature sensors indicate temperature keeps rising above the threshold which the thermostat is tasked with maintaining
b. No water movement is sensed by any flow meter indicating that pressure is not being reduced by the pressure regulator
c. Temperature sensed by lowest sensor (sensor at lowest vertical height) exceeds a predetermined threshold. Since heat rises, sensors deployed adjacent the top of the tank show the highest reading; hence if the lowest sensor is hot, this indicates a danger signal.

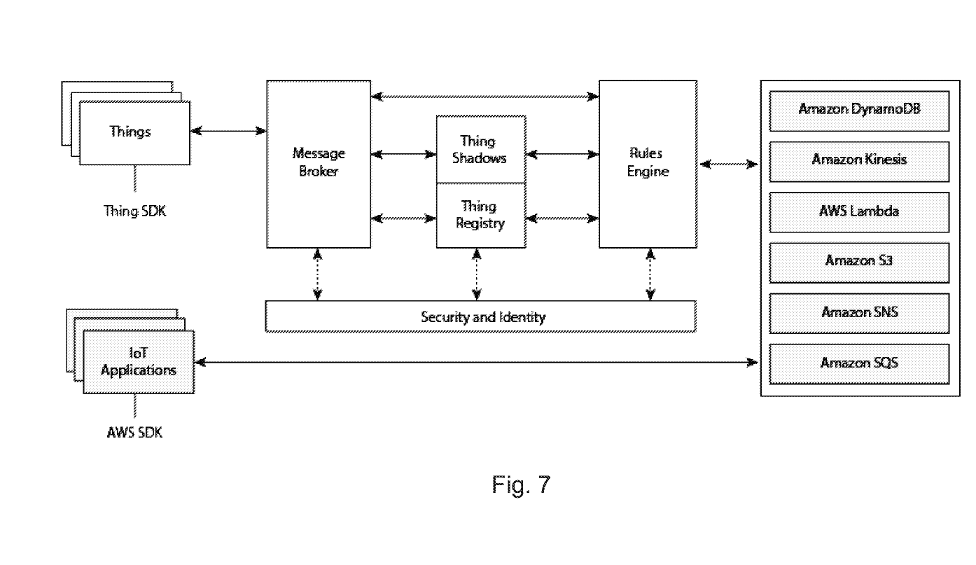

FIG. 7 is an example Amazon Web Services (AWS)-based implementation of the central server described herein. It is appreciated that alternatively, the central server may comprise an actual physical server farm or may be based on any other suitable cloud service provider rather than necessarily Amazon, and may utilize any subset of, rather than all of, the cloud services specifically described herein and may alternatively include or utilize any suitable compute, storage, networking, database, analytics, application services, deployment, management, mobile, developer tools and Internet of things services in addition to or instead of cloud services specifically described herein.

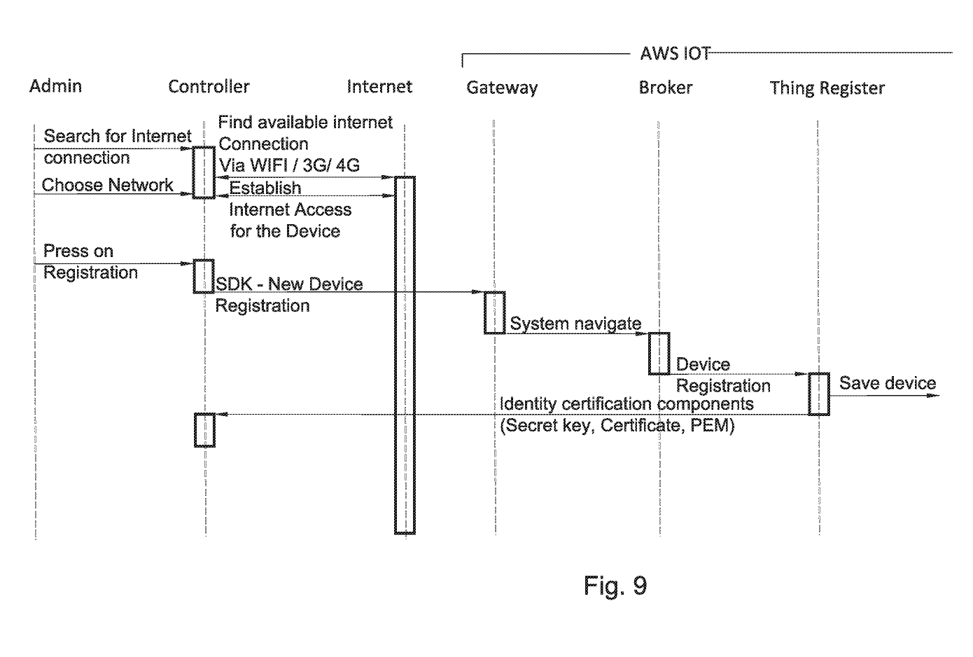

According to certain embodiments, IoT (Internet of Things) functionality is provided by the system shown and described herein so as to enable consumers to have the right amount of water, at the right temperature, at the right time, typically while also reducing use of electricity and/or extending boiler life-time and/or proactively detecting or predicting and responding to boiler malfunctions. Suitable main processes provided within the iOT (Internet of Things) functionality are illustrated in FIGS. 9-12.

According to certain embodiments, an original equipment manufacturer (OEM) feature is added retroactively to product lines from legacy boiler manufacturers including sensors which may be legacy sensors i.e. may already be deployed alternatively may be retroactively deployed within the boiler, operative in conjunction with a local (legacy or retroactively introduced) smart controller and/or smart switch e.g. controlling the boiler's hot water outlet which serves the household's hot water need via the household piping system.

These, typically in conjunction with the cloud server and, optionally, associated mobile application, enable consumers, manufacturers and installers to manage and control the boiler. In the following description Manufacture/Distributer/Installer User/Admin are terms used interchangeably.

A Broker (aka Message Broker may be provided at the central server, to Convert/Translate and route (aka refer) messages from the controller to a relevant central server component e.g. Amazon IOT component. IOT components may for example include some or all of:

Thing Register—An IoT component operative for the registration of a new controller in the DB.

Thing Shadows—An IoT component operative for storing and retrieving thing current state of the device E.g. as described below.

Rule Engine—An IoT component operative for generating, maintaining and applying a set of rules that creates actions. Actions may include local controller behavior which the rules stipulate should occur at specific times of the day, and/or responsive to boiler sensors' temperature and/or responsive to boiler water meter-sensed water flow, etc. Actions may also include central server actions such as saving a record (e.g. of a maintenance visit to boiler x conducted by maintenance workforce person y on date z) in DB e.g. data repository or sending the user an email or other message or remotely turning the device off e.g. de-activating its heating element.

A First Time Registration process may be provided which may include sub processes:

Registration of the device e.g. boiler, creating a new customer in the data repository, and pairing that customer (aka boiler end user) to a registered device. These sub-processes need not occur simultaneously, and most frequently occur at separate times.

Device (First Time) Registration, e.g. as illustrated in FIG. 9, typically includes connecting the device to the Internet, and to registering the device in the DB e.g. data repository. Using the connection to the Internet provided thereby, the local controller may communicate with the central server that typically both sends commands to the controller, and receives real-time reporting from the controller. Typically, the installer from the maintenance workforce presses on the controller's control panel to open a port for searching a WIFI network. After choosing the end-user network, the installer connects the controller to the Internet.

The controller can then communicate with the server for first time registration. The controller typically sends its unique particulars to a gateway (typically operative to identify and route to an Amazon (say) IOT component in the central server) which identifies whether the registration request is new, or whether the request is from an already-registered device. In this case, this is the first time this particular device is connecting with the server, so the gateway typically routes the request to the Message Broker which recognizes that the device is not registered and requires a certificate. Then, the Message Broker refers the request for new registration to a Things Register which sends back to the controller a Secret Key, Certificate and PEM. These are used for future identification processes from here on, so they are normally saved as unique device details in the server's data repository DB.

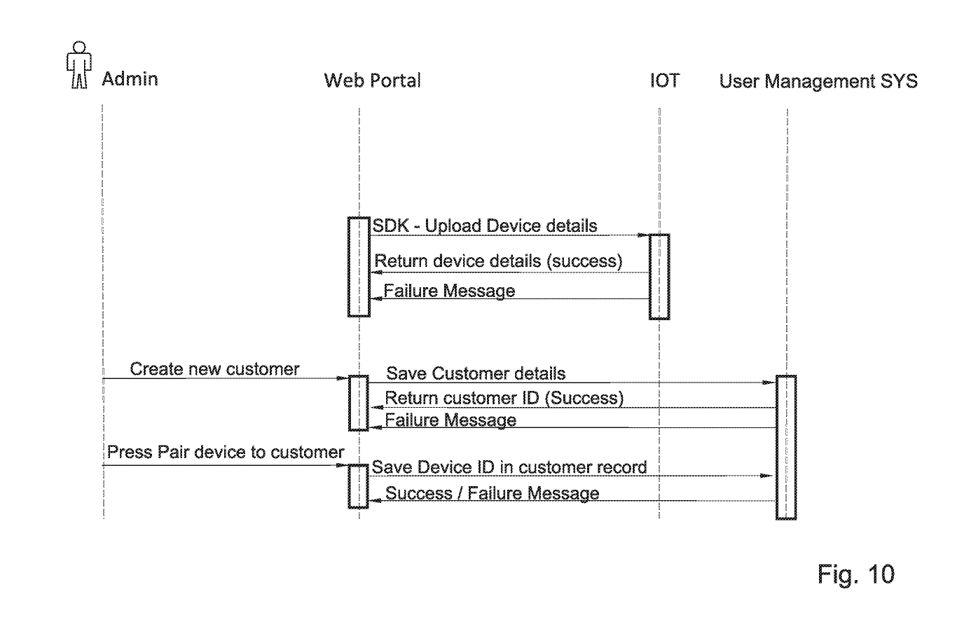

Following the initial registration process, the device is installed in the system and the system can obtain reports and orders from the device. However, before the device is activated, it is typically paired with a customer e.g. as illustrated in FIG. 10. A device e.g. boiler, once registered in the DB, typically automatically appears in the system Web Portal, so the Admin can view the device details immediately after the registration process. The Admin typically logs into to the Web Portal and creates a new customer.

According to certain embodiments, when creating a new customer, one of the parameters may be ‘Pair Device’. In this case, after clicking on the Pair Device button, a list of devices known to the DB may open and the Admin can choose the desired device. After saving all details the Device ID may be saved in the customer record, thus completing the pairing process. Alternatively, any other scheme may be employed to pair a device to a consumer.

Data transferred between the server and the controller may include any of the following:

A. Data collection—The controller may send data collected from boiler sensors, on occasion e.g. periodically e.g. every X minutes to the server.
B. A rule pre-defined in the server sends auto-command to the controller e.g., say, to disable the heating element until further notice.
C. Customer or Admin manually activate the controller from the system application/web portal.
For example:
A: A message is sent from the controller to the gateway. The gateway identifies the controller and “opens the door” to the message broker. The message broker decrypts the message and passes the decrypted message on to the Thing shadows. The Thing shadows compares between the most recently stored device status and the new one, and typically merges the two. The controller may send only data that has changed from last time; the server may merge the newly arrived data by replacing the appropriate old fields with the appropriate newly arrived data while preserving fields not changed. The merged message is then sent to the Rule Engine to determine, according to pre-defined rules, which action/s may be required. Alternatively, if an entire set of new data is sent by the controller, the entire old data set may simply be replaced by the newly arrived data.
B: The rule engine is activated based on rules pre-defined for deciding on actions needed.
C: The same process as described above in A occurs, only this time the user is required to provide identification. The central server approaches a user management system in the central server for user identification and compares the device ID (e.g. for embodiments in which user name and password are used for authentication of end user x to specific controller y having a specific, registered, controller ID). If the central server find no errors, the central server may route the message to the device, and the central server sends the message to the gateway and the process is then the same as A.

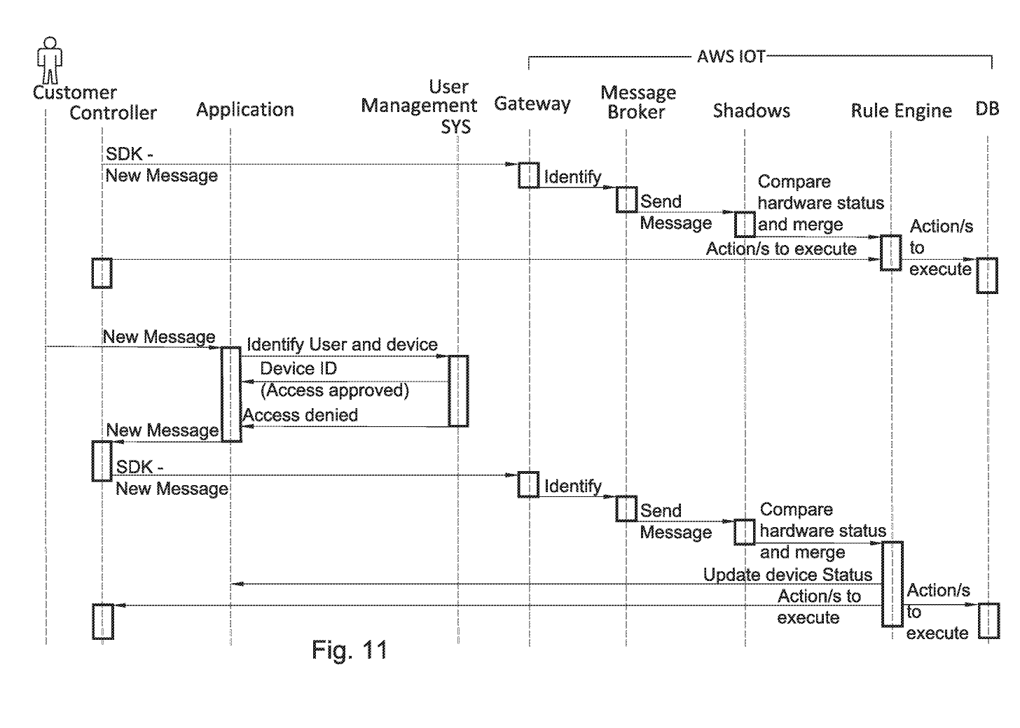

An example information/data flow process is illustrated in FIG. 11.

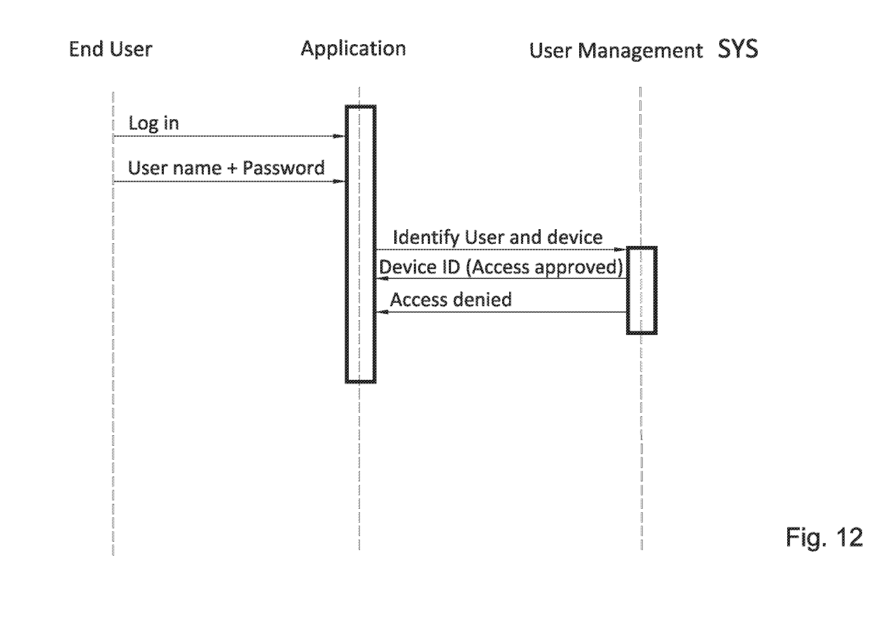

Any suitable user login process, e.g. as shown in FIG. 12, may be provided between an individual system user and the user management system. Typically, the user logs in from a mobile application or through a web portal. In both cases the system typically identifies the user via the user management system and returns the user and device ID as outputs, to allow the application to send the message to the device.

Referring again to the table of FIGS. 6a-6f, this table presents sensor values, actions and policies, some or all of which may be provided in accordance with certain embodiments, either stand-alone or in conjunction with the system of FIG. 1 and/or with any of the processes of FIGS. 2-5, 8a-8b, or all of these. The table may include some or any suitable subset of the rows and columns illustrated by way of example. The term “water flow circles” is intended to include, say, an auxiliary water flow circle from the boiler to the solar panel and back again (as hot water), and a main water flow circle from the house water supply to the boiler (as cold water, via main water entry point 40 to the boiler pipe) and back again (as hot water, via hot water pipe 42 exiting the boiler). The term “electrical issues” e.g. in FIG. 6e is intended to refer to any sort of situation in which the controller, which may have several connection points to the electricity system of the heating element and/or legacy boiler thermostat 24, detects thereby an electrical abnormality and responsively, sends an alert to the server/cloud which in turn may alert the manufacturer and/or consumer e.g. as described herein. It is appreciated that any time periods appearing, say in the “Example data retention & presentation policy” column—e.g. “month”, “week” etc. —are merely exemplary; any other suitable period of time may be used.

Israel Patent No. 210075 describes a system for controlling temperature of water in a hot water installation; its disclosure is incorporated herein by reference. It is appreciated that a boiler having some or all of the characteristics shown and described in FIG. 1 of Israel Patent No. 210075 or the description thereof, may be employed in conjunction with any of the embodiments shown and described herein. Alternatively or in addition, the control unit having some or all of the characteristics shown and described in FIG. 1 of Israel Patent No. 210075 or the description thereof, may be employed in conjunction with any of the embodiments shown and described herein as a controller co-located with the boiler. Alternatively or in addition, the user interface having some or all of the characteristics shown and described in FIG. 2 of Israel Patent No. 210075 or the description thereof, may be employed in conjunction with any of the embodiments shown and described herein. Alternatively or in addition, deployment within a building of individual boilers, having some or all of the characteristics shown and described in FIG. 3 of Israel Patent No. 210075 or the description thereof, may be provided in conjunction with any of the embodiments shown and described herein.

Advantages of certain embodiments include particularly effective detection and handling of boiler failure, such as but not limited to all or any subset of thermostat failure, pressure regulator failure, heating element failure, and leakage.

For example, in the event of thermostat failure, in conventional boiler systems, the boiler may appear to the end user to continue working normally since hot water continues to be available. Nonetheless, water loss is occurring, unseen in conventional systems but detected according to certain embodiments described herein, e.g. due to a pressure regulator which initiates release of water to reduce pressure. Electricity is also being wasted, since the system keeps heating even when the water is very hot, e.g. when the boiler switch is forgotten by the end-user in its ON mode, as frequently happens. Not only does early detection of thermostat failure as described herein prevent the above, if an early service call is initiated e.g. by the manufacturer, typically at times of low workload for the service crew, the early detection also deflects risk of explosion which is high if thermostat failure occurs in conjunction with pressure regulator failure.

Any suitable method may be employed for identifying thermostat failure such as but not limited to detecting conductivity failure by the controller (10 in FIG. 1.) Controller 10 may be connected to plural (e.g. 4) different locations in the boiler electricity system Which facilitates analysis of whether the electricity circuit to the heating system, or to the thermostat, may be closed. And/or, determining that the thermostat is failing may be accomplished while the heating system is heating the water, if temperature detected by sensor 22 in FIG. 1 is found by the controller to be rising over a certain predefined limit. Then, if water flow sensors 14 and 16 in FIG. 1 are not detecting leakage the controller 10 may conclude that the thermostat is failing and the pressure release mechanism is not working. Early detection of water leakage yielded by certain embodiments described herein prevents standing water issues, such as mosquitoes and mildew, and also prevents unnecessary deterioration of pipes/boilers, since an easily fixed small crack, if not detected early, may turn into a hole large enough to necessitate infrastructure or boiler replacement. This may be prevented if an early service call is initiated e.g. by the manufacturer, typically at times of low workload for the service crew. For example, consider the water flow circle from the boiler to the solar panel 26 in FIG. 1 and back. Cold water from the boiler passes through water flow sensor 12 in FIG. 1 Then flows back to the boiler through water flow sensor 18 of FIG. 1. If there is a deviation in between the out/in water flow (between the readings of the 2 sensors at corresponding times), the controller may by analysis determine that water is leaking and send an alert to the server/cloud service. Similarly, regarding the main water circuit which receives incoming cold water from the main house pipe through water flow sensor 16 of FIG. 1 and returns, to the house, hot water which flows through water flow meter 14 of FIG. 1, a discrepancy between the readings of the 2 sensors 14, 16 at corresponding times allows the controller 10, by analysis, to determine that water is leaking and to send an alert to the server/cloud service.

Pressure regulator failure again is not apparent to the end-user whose boiler ostensibly continues to keep working normally. But if the thermostat is failing as well as the pressure regulator, the next time the user forgets to turn off her or his water heater, the boiler is at very high risk for explosion: this may be avoided by early detection of pressure regulator failure yielded by embodiments described herein. For example, if temperature is high since the heating system is on, and if the thermostat is failing, pressure may get high. If the pressure regulator is working, water will be released responsively; otherwise water will not be released. Therefore, in this instance, water leakage at a predetermined level of high temperature, indicates proper functioning of the pressure regulator whereas lack of water leakage (no difference between readings of relevant water flow sensors) is indicative of a malfunctioning pressure regulator.

Heating element failure also may not be detected during the entire summer period. Absent certain embodiments shown and described herein which yield early detection of heating element failure, this failure becomes apparent only during winter which is peak season in terms of service calls, which is inconvenient for the manufacturer and for the end user in terms of long waiting time during which the end user has no hot water. The controller 10 of FIG. 1 may be connected to the electricity system of the heating element both upstream and downstream thereof. Therefore, the controller may, by comparison between these two connection points, determine whether conductivity measurement and resistance readings are normal. If not the analysis result is that the heating element 25 of FIG. 1 may be malfunctioning and the controller may send a suitable alert to the server/cloud.

Malfunctioning of a legacy heat acceleration unit 31, if present, may or may not be monitored.

It is appreciated that implementation via a cellular app as described herein is but an example and instead, embodiments of the present invention may be implemented, say, as a smartphone SDK; as a hardware component; as an STK application, or as suitable combinations of any of the above.

It is appreciated that terminology such as “mandatory”, “required”, “need” and “must” refer to implementation choices made within the context of a particular implementation or application described herewithin for clarity and are not intended to be limiting since in an alternative implantation, the same elements might be defined as not mandatory and not required or might even be eliminated altogether.

Components described herein as software may, alternatively, be implemented wholly or partly in hardware and/or firmware, if desired, using conventional techniques, and vice-versa. Each module or component or processor may be centralized in a single physical location or physical device or distributed over several physical locations or physical devices.

Included in the scope of the present disclosure, inter alia, are electromagnetic signals in accordance with the description herein. These may carry computer-readable instructions for performing any or all of the operations of any of the methods shown and described herein, in any suitable order including simultaneous performance of suitable groups of operations as appropriate; machine-readable instructions for performing any or all of the operations of any of the methods shown and described herein, in any suitable order; program storage devices readable by machine, tangibly embodying a program of instructions executable by the machine to perform any or all of the operations of any of the methods shown and described herein, in any suitable order; a computer program product comprising a computer useable medium having computer readable program code, such as executable code, having embodied therein, and/or including computer readable program code for performing, any or all of the operations of any of the methods shown and described herein, in any suitable order; any technical effects brought about by any or all of the operations of any of the methods shown and described herein, when performed in any suitable order; any suitable apparatus or device or combination of such, programmed to perform, alone or in combination, any or all of the operations of any of the methods shown and described herein, in any suitable order; electronic devices each including at least one processor and/or cooperating input device and/or output device and operative to perform e.g. in software any operations shown and described herein; information storage devices or physical records, such as disks or hard drives, causing at least one computer or other device to be configured so as to carry out any or all of the operations of any of the methods shown and described herein, in any suitable order; at least one program pre-stored e.g. in memory or on an information network such as the Internet, before or after being downloaded, which embodies any or all of the operations of any of the methods shown and described herein, in any suitable order, and the method of uploading or downloading such, and a system including server/s and/or client/s for using such; at least one processor configured to perform any combination of the described operations or to execute any combination of the described modules; and hardware which performs any or all of the operations of any of the methods shown and described herein, in any suitable order, either alone or in conjunction with software. Any computer-readable or machine-readable media described herein is intended to include non-transitory computer- or machine-readable media.

Any computations or other forms of analysis described herein may be performed by a suitable computerized method. Any operation or functionality described herein may be wholly or partially computer-implemented e.g. by one or more processors. The invention shown and described herein may include (a) using a computerized method to identify a solution to any of the problems or for any of the objectives described herein, the solution optionally include at least one of a decision, an action, a product, a service or any other information described herein that impacts, in a positive manner, a problem or objectives described herein; and (b) outputting the solution.

The system may, if desired, be implemented as a web-based system employing software, computers, routers and telecommunications equipment as appropriate.

Any suitable deployment may be employed to provide functionalities e.g. software functionalities shown and described herein. For example, a server may store certain applications, for download to clients, which are executed at the client side, the server side serving only as a storehouse. Some or all functionalities e.g. software functionalities shown and described herein may be deployed in a cloud environment. Clients e.g. mobile communication devices such as smartphones may be operatively associated with, but external to the cloud.

The scope of the present invention is not limited to structures and functions specifically described herein and is also intended to include devices which have the capacity to yield a structure, or perform a function, described herein, such that even though users of the device may not use the capacity, they are if they so desire able to modify the device to obtain the structure or function.

Features of the present invention, including operations, which are described in the context of separate embodiments may also be provided in combination in a single embodiment. For example, a system embodiment is intended to include a corresponding process embodiment and vice versa. Also, each system embodiment is intended to include a server-centered “view” or client centered “view”, or “view” from any other node of the system, of the entire functionality of the system, computer-readable medium, apparatus, including only those functionalities performed at that server or client or node. Features may also be combined with features known in the art and particularly although not limited to those described in the Background section or in publications mentioned therein.

Conversely, features of the invention, including operations, which are described for brevity in the context of a single embodiment or in a certain order may be provided separately or in any suitable subcombination, including with features known in the art (particularly although not limited to those described in the Background section or in publications mentioned therein) or in a different order. “e.g.” is used herein in the sense of a specific example which is not intended to be limiting. Each method may comprise some or all of the operations illustrated or described, suitably ordered e.g. as illustrated or described herein.

Devices, apparatus or systems shown coupled in any of the drawings may in fact be integrated into a single platform in certain embodiments or may be coupled via any appropriate wired or wireless coupling such as but not limited to optical fiber, Ethernet, Wireless LAN, HomePNA, power line communication, cell phone, Smart Phone (e.g. iPhone), Tablet, Laptop, PDA, Blackberry GPRS, Satellite including GPS, or other mobile delivery. It is appreciated that in the description and drawings shown and described herein, functionalities described or illustrated as systems and sub-units thereof can also be provided as methods and operations therewithin, and functionalities described or illustrated as methods and operations therewithin can also be provided as systems and sub-units thereof. The scale used to illustrate various elements in the drawings is merely exemplary and/or appropriate for clarity of presentation and is not intended to be limiting.

1. A smart boiler system operative in conjunction with a plurality of boilers wherein each individual boiler in said plurality is equipped with at least one sensor monitoring an aspect of the individual boiler's water heating functionality and a local controller collecting data from said sensor and communicating at least some of said data via a data network to a remote server, the system comprising:
a boiler data repository comprising computer storage operative to maintain at least some of said data; and
a central server in data communication with said data network and including a processor having at least one operational mode including a maintenance-needs-detection operational mode which is operative to scan data stored in said repository, on occasion, and to rank, accordingly, said plurality of boilers in terms of at least one predetermined criterion defining at least one maintenance need, and to provide at least one “push” output indicating a subset of said plurality of boilers currently ranking high in terms of said at least one predetermined criterion defining at least one maintenance need.

2. A system according to claim 1 wherein said central server has plural operational modes and wherein said maintenance-needs-detection operational mode is activated when a boiler maintenance workforce tends to be underemployed and is disabled when a boiler maintenance workforce tends to be fully employed, thereby to provide differential operation on-season and off-season.

3. A system according to claim 1 wherein said push output comprises, for at least some boilers in said subset, a replace/service indication of whether said boiler should be serviced or replaced, based on predefined logic defining whether a boiler should be serviced or should be replaced by combining said data.

4. A system according to claim 1 wherein said sensor comprises plural temperature sensors distributed at respective plural temperature sensor locations throughout the boiler, wherein said data includes water temperature readings collected by the controller from said plural temperature sensors and stamped to indicate which of said plural temperature sensors provided each reading and wherein computing said criterion defining at least one maintenance need includes comparing at least some of said water temperature readings to identify impaired functioning of at least one of a boiler's heating elements and, all other things being equal, to rank boilers suffering from impaired functioning of at least one heating element higher than boilers not suffering from impaired functioning of at least one heating element.

5. A system according to claim 1 wherein said boiler has plural water flow points each including a water inlet or a water outlet and said sensor comprises plural flow meters monitoring said plural water flow points and wherein said data includes water flow readings collected by the controller from said plural flow meters and stamped to indicate which of said plural flow meters provided each reading and wherein computing said criterion defining at least one maintenance need includes comparing at least some of said water flow readings to identify at least one water leakage malfunction and, all other things being equal, to rank boilers having at least one water leakage malfunction higher than boilers not having at least one water leakage malfunction.

6. A system according to claim 1 wherein said sensor comprises at least one pressure sensor interior of said boiler and wherein said remote server is operative to provide a high pressure emergency alert by applying predetermined boiler explosion prediction logic to said pressure sensor, even if said remote server is not in said maintenance-needs-detection operational mode.

7. A system according to claim 1 wherein said controller is also operative to control at least one aspect of operation of said boiler.

8. A system according to claim 7 and wherein said remote server, when in said maintenance-needs-detection operational mode, is operative to command at least one individual controller, which is local with respect to at least one individual boiler, to generate at least one predetermined testing state by controlling at least one aspect of operation of said boiler thereby to convert said boiler's current state to said testing state.

9. A system according to claim 8 and wherein said testing state comprises a specific interior temperature of water inside said boiler.

10. A system according to claim 1 wherein said remote server is operative, at least once, to compare data stored in said repository pertaining to an individual boiler to data stored in said repository pertaining to at least one boiler other than said individual boiler, thereby to identify at least one deviation of said individual boiler from at least one norm and wherein said criterion defining at least one maintenance need is computed as a function of at least said deviation from said norm.

11. A system according to claim 10 wherein said repository stores, for each specific boiler, that specific boiler's date of installation and wherein said data stored in said repository pertaining to at least one boiler other than said individual boiler comprises data pertaining only to a set of boilers whose date of installation is newer than a predetermined threshold data such that said norm comprises a benchmark of ideal performance.

12. A system according to claim 10 wherein said repository stores, for each specific boiler, that specific boiler's geographical location and wherein said set of boilers to which said individual boiler is compared includes only boilers whose geographical location shares weather conditions with said individual location as determined by a predetermined rule applied to boiler geographical locations thereby to identify geographical regions in which weather conditions are assumed to be uniform.

13. A system according to claim 5 wherein said “push” output comprises a diagnosis of the water leakage malfunction's location based on known locations of said plural flow meters and on said water flow readings stamped to indicate which of said plural flow meters provided each reading.

14. A system according to claim 2 wherein said maintenance-needs-detection operational mode is activated responsive to an input indication determined by processing at least one output from a boiler maintenance work force scheduler indicating that a boiler maintenance work force managed by the scheduler is underemployed and is disabled responsive to an input indication determined by processing at least one output from the boiler maintenance work force scheduler indicating that the boiler maintenance work force managed by the scheduler is fully employed.

15. A computer program product, comprising a non-transitory tangible computer readable medium having computer readable program code embodied therein, said computer readable program code adapted to be executed to implement a method for providing smart boiler system operative in conjunction with a plurality of boilers wherein each individual boiler in said plurality is equipped with at least one sensor monitoring an aspect of the individual boiler's water heating functionality and a local controller collecting data from said sensor and communicating at least some of said data via a data network to a remote server, the method comprising:
Providing a boiler data repository comprising computer storage operative to maintain at least some of said data; and
Providing a central server in data communication with said data network and including a processor having at least one operational mode including a maintenance-needs-detection operational mode which is operative to scan data stored in said repository, on occasion, and to rank, accordingly, said plurality of boilers in terms of at least one predetermined criterion defining at least one maintenance need, and to provide at least one “push” output indicating a subset of said plurality of boilers currently ranking high in terms of said at least one predetermined criterion defining at least one maintenance need.

16. A system according to claim 1 wherein said ranking is determined at least partly by identifying at least one flow circle, monitored by plural flow sensors, which is leaking, by comparing plural readings obtained at corresponding times from said plural sensors.

17. A method for providing smart boiler system operative in conjunction with a plurality of boilers wherein each individual boiler in said plurality is equipped with at least one sensor monitoring an aspect of the individual boiler's water heating functionality and a local controller collecting data from said sensor and communicating at least some of said data via a data network to a remote server, the method comprising:
Providing a boiler data repository comprising computer storage operative to maintain at least some of said data; and
Providing a central server in data communication with said data network and including a processor having at least one operational mode including a maintenance-needs-detection operational mode which is operative to scan data stored in said repository, on occasion, and to rank, accordingly, said plurality of boilers in terms of at least one predetermined criterion defining at least one maintenance need, and to provide at least one “push” output indicating a subset of said plurality of boilers currently ranking high in terms of said at least one predetermined criterion defining at least one maintenance need.

18. The method of claim 17 and also comprising providing a heat regulation malfunction alert indicating at least one of a heating element and a thermostat is faulty, if said flow circle is deemed to be leaking due to operation of a pressure regulator, and providing a leakage alert, otherwise.

19. The method of claim 17 and also comprising providing a pressure regulation malfunction alert if pressure is sensed and found to exceed a high-pressure threshold, and no leakage is identified.
